(19) United States
(12) Patent Application Publication
(10) Pub. No.: US 2020/0364678 A1
(43) Pub. Date: Nov. 19, 2020

(54) System, Method, and Computer Program Product for Conducting a Payment Transaction

(71) Applicant: Visa International Service Association, San Francisco, CA (US)

(72) Inventor: Robert Chumbley, Round Rock, TX (US)

(21) Appl. No.: 16/638,518

(22) PCT Filed: Aug. 22, 2017
(86) PCT No.: PCT/US2017/047947

§ 371 Date: Feb. 12, 2020

(51) Int. Cl. G06Q 20/02; G06Q 20/36; G06Q 20/20; G06Q 20/32

(52) U.S. Cl. CPC G06Q 20/027; G06Q 20/3278; G06Q 20/20; G06Q 20/36

(57) ABSTRACT

Provided is a computer-implemented method for conducting a payment transaction. The method may include receiving payment gateway communication data associated with a communication channel of a user, communicating a payment request message that includes the payment gateway communication data, generating a payment request notification message, where the payment request notification message includes a link to a network resource associated with a payment gateway system, communicating the payment request notification message to a user device associated with the user using the communication channel, receiving a payment request response message that includes payment method data communicated by the user device independent of a short range wireless communication connection, where the payment method data is communicated via the network resource associated with the payment gateway system, and processing at least one payment transaction using the payment method data communicated via the network resource. A system and computer program product are also disclosed.

### BACKGROUND OF THE INVENTION

### 1. Field of the Invention

This invention relates generally to systems, apparatus, and methods for conducting a payment transaction and, in one particular embodiment, to a system, product, and method for conducting a payment transaction where payment method data is communicated and/or received independent of a short range wireless communication connection.

### 2. Technical Considerations

Contactless payment systems may include point-of-sale (POS) devices and electronic devices (e.g., mobile devices, smartphones, and/or the like) that may use a short range wireless communication connection (e.g., a short range wireless communication connection that uses radio frequency identification (RFID) and/or a short range wireless communication connection that uses near field communication (NFC) protocol) to communicate and/or receive payment method data. In one example, an electronic device may communicate payment method data to a POS device (e.g., a contactless POS device) via a short range wireless communication connection to conduct a payment transaction involving a user associated with the electronic device and a merchant associated with the POS device.

However, in some instances, the POS device may not be capable of receiving payment method data via a short range wireless communication connection. Such a POS device may not be able to conduct a payment transaction where payment method data is to be received by the POS device via a short range wireless communication connection. Further, in some instances, a mobile device may not be enabled to communicate payment method data via a short range wireless communication connection and is therefore unable to conduct a payment transaction where payment method data is to be communicated to the POS device via a short range wireless communication connection.

### SUMMARY OF THE INVENTION

Accordingly, it is an object of the present invention to provide systems, apparatus, and/or methods for conducting a payment transaction that overcomes some or all of the deficiencies of the prior art.

According to non-limiting embodiments, provided is a computer-implemented method for conducting a payment transaction. In some non-limiting embodiments, a method for conducting a payment transaction may include receiving, with at least one processor, payment gateway communication data associated with a communication channel of a user, communicating, with at least one processor, a payment request message based on receiving the payment gateway communication data, where the payment request message includes the payment gateway communication data.

The method may further include generating, with at least one processor, a payment request notification message based on receiving the payment request message, where the payment request notification message comprises a link to a network resource associated with a payment gateway system; communicating, with at least one processor, the payment request notification message to a user device associated with the user, where communicating the payment request notification message comprises communicating the payment request notification message using the communication channel associated with the payment gateway communication data; and receiving, with at least one processor, a payment request response message. The payment request response message may include payment method data communicated by the user device independent of a short range wireless communication connection and the payment method data may be communicated via the network resource associated with the payment gateway system.

The method may further include processing, with at least one processor, at least one payment transaction involving the user and a merchant using the payment method data communicated via the network resource.

According to non-limiting embodiments, provided is a system for conducting a payment transaction. In some non-limiting embodiments, the system for conducting a payment transaction may include at least one processor, where the at least one processor may be programmed or configured to receive payment gateway communication data associated with a communication channel of a user; communicate a payment request message based on receiving the payment gateway communication data, where the payment request message comprises the payment gateway communication data; and generate a payment request notification message based on receiving the payment request message, where the payment request notification message comprises a link to a network resource associated with a payment gateway system.

Further, the at least one processor may be programmed or configured to communicate the payment request notification message to a user device associated with the user using the communication channel associated with the payment gateway communication data; receive a payment request response message, where the payment request response message comprises payment method data communicated by the user device independent of a short range wireless communication connection and the payment method data is communicated via the network resource associated with the payment gateway system; and process at least one payment transaction involving the user and a merchant using the payment method data communicated via the network resource.

According to non-limiting embodiments, provided is a computer program product for conducting a payment transaction. In some non-limiting embodiments, the computer program product for conducting a payment transaction may include at least one non-transitory computer-readable medium including one or more instructions that, when executed by at least one processor, cause the at least one processor to receive payment gateway communication data associated with a communication channel of a user; communicate a payment request message, where the payment request message comprises the payment gateway communication data; and generate a payment request notification message based on receiving the payment request message, where the payment request notification message comprises a link to a network resource associated with a payment gateway system.

The one or more instructions, when executed by at least one processor, may further cause the at least one processor to communicate the payment request notification message to a user device associated with the user using the communication channel associated with the payment gateway communication data, receive a payment request response message, where the payment request response message comprises payment method data communicated by the user device independent of a short range wireless communication connection and the payment method data is communicated via the network resource associated with the payment gateway system, and process at least one payment transaction involving the user and a merchant using the payment method data communicated via the network resource.

Further embodiments or aspects are set forth in the following numbered clauses:

Clause 1: A computer-implemented method for conducting a payment transaction, the method comprising: receiving, with at least one processor, payment gateway communication data associated with a communication channel of a user; communicating, with at least one processor, a payment request message based on receiving the payment gateway communication data, wherein the payment request message comprises the payment gateway communication data; generating, with at least one processor, a payment request notification message based on receiving the payment request message, wherein the payment request notification message comprises a link to a network resource associated with a payment gateway system; communicating, with at least one processor, the payment request notification message to a user device associated with the user, wherein communicating the payment request notification message comprises communicating the payment request notification message using the communication channel associated with the payment gateway communication data; receiving, with at least one processor, a payment request response message, wherein the payment request response message comprises payment method data communicated by the user device independent of a short range wireless communication connection, wherein the payment method data is communicated via the network resource associated with the payment gateway system; and processing, with at least one processor, at least one payment transaction involving the user and a merchant using the payment method data communicated via the network resource.

Clause 2: The method of clause 1, wherein the payment gateway communication data comprises at least one of the following: communication channel type data associated with a type of the communication channel of the user; communication channel user data associated with contact information of the user; or any combination thereof.

Clause 3: The method of clauses 1 or 2, wherein communicating the payment request notification message to the user device comprises communicating the payment request notification message to the user device based at least partially on the communication channel type data, the communication channel user data, or any combination thereof.

Clause 4: The method of any of clauses 1-3, further comprising receiving transaction data associated with the at least one payment transaction, wherein the transaction data comprises transaction identifier data associated with an identifier of the at least one payment transaction, and wherein generating the payment request notification message comprises: generating the link to the network resource associated with the payment gateway system based on the transaction identifier data.

Clause 5: The method of any of clauses 1-4, wherein the user device comprises a mobile device, wherein the payment gateway communication data comprises communication channel user data, and wherein the communication channel user data comprises at least one of the following: a mobile device number of the mobile device associated with the user; an email address of an email account associated with the user; or a user name of a social media account associated with the user, and wherein communicating the payment request notification message using the communication channel associated with the payment gateway communication data comprises: communicating the payment request notification message using the communication channel associated with the mobile device number of the mobile device associated with the user, the email address of an email account associated with the user, or the social media account associated with the user.

Clause 6: The method of any of clauses 1-5, further comprising: receiving transaction data associated with the at least one payment transaction; and generating the link to the network resource based at least partially on at least one of the following: a merchant order identifier included in the transaction data, a point-of-sale device identifier included in the transaction data, a transaction identifier included in the transaction data, or any combination thereof.

Clause 7: A system for conducting a payment transaction, the system comprising: at least one processor, wherein the at least one processor is programmed or configured to: receive payment gateway communication data associated with a communication channel of a user; communicate a payment request message based on receiving the payment gateway communication data, wherein the payment request message comprises the payment gateway communication data; generate a payment request notification message based on receiving the payment request message, wherein the payment request notification message comprises a link to a network resource associated with a payment gateway system; communicate the payment request notification message to a user device associated with the user using the communication channel associated with the payment gateway communication data; receive a payment request response message, wherein the payment request response message comprises payment method data communicated by the user device independent of a short range wireless communication connection, and wherein the payment method data is communicated via the network resource associated with the payment gateway system; and process at least one payment transaction involving the user and a merchant using the payment method data communicated via the network resource.

Clause 8: The system of clause 7, wherein the at least one processor comprises a processor of a point-of-sale device associated with the merchant, and the processor of the POS device is programmed or configured to: receive the payment gateway communication data; and communicate the payment gateway communication data.

Clause 9: The system of clauses 7 or 8, wherein the at least one processor is further programmed or configured to: receive a message comprising data associated with a result of processing the payment transaction.

Clause 10: The system of any of clauses 7-9, wherein the at least one processor, when receiving the payment gateway communication data associated with the communication channel of the user, is programmed or configured to: receive communication channel type data associated with a type of the communication channel of the user; and receive communication channel user data associated with contact information of the user after receiving the communication channel type data.

Clause 11: The system of any of clauses 7-10, wherein the network resource comprises a web page associated with the payment gateway system, and wherein the link comprises a Uniform Resource Locator for the web page.

Clause 12: The system of any of clauses 7-11, wherein the short range wireless communication connection is a short range wireless communication connection between the user device associated with the user and a point-of-sale device associated with the merchant.

Clause 13: The system of any of clauses 7-12, wherein the at least one processor, when communicating the payment request notification message to the user device associated with the user, is programmed or configured to: communicate a text message to the user device associated with the user, wherein the text message comprises the link to the network resource.

Clause 14: The system of any of clauses 7-13, wherein the at least one processor comprises a processor of the payment gateway system, and the processor of the payment gateway system is programmed or configured to: communicate the payment request notification message to the user device associated with the user; and receive the payment request response message that comprises payment method data communicated by the user device.

Clause 15: A computer program product for conducting a payment transaction, the computer program product comprising at least one non-transitory computer-readable medium including one or more instructions that, when executed by at least one processor, cause the at least one processor to: receive payment gateway communication data associated with a communication channel of a user; communicate a payment request message, wherein the payment request message comprises the payment gateway communication data; generate a payment request notification message based on receiving the payment request message, wherein the payment request notification message comprises a link to a network resource associated with a payment gateway system; communicate the payment request notification message to a user device associated with the user using the communication channel associated with the payment gateway communication data; receive a payment request response message, wherein the payment request response message comprises payment method data communicated by the user device independent of a short range wireless communication connection, and wherein the payment method data is communicated via the network resource associated with the payment gateway system; and process at least one payment transaction involving the user and a merchant using the payment method data communicated via the network resource.

Clause 16: The computer program product of clause 15, wherein the one or more instructions, that cause the at least one processor to generate the payment request notification message, cause the at least one processor to: generate the link to the network resource based on transaction data associated with at least one payment transaction.

Clause 17: The computer program product of clauses 15 or 16, wherein the network resource comprises a web page associated with the payment gateway system and wherein the link comprises a Uniform Resource Locator for the web page.

Clause 18: The computer program product of any of clauses 15-17, wherein the one or more instructions, when executed by the at least one processor, further cause the at least one processor to: receive a message comprising data associated with a result of processing the at least one payment transaction.

Clause 19: The computer program product of any of clauses 15-18, wherein the one or more instructions, when executed by the at least one processor, further cause the at least one processor to: communicate the payment method data to a transaction service provider system based on receiving the payment request response message.

Clause 20: The computer program product of any of clauses 15-19, wherein the one or more instructions, when executed by the at least one processor, further cause the at least one processor to: generate the payment request message, wherein the payment request message comprises the payment gateway communication data and transaction data associated with the at least one payment transaction involving the user and the merchant.

Clause 21: A method for conducting a payment transaction, the method comprising: receiving, with at least one processor, mobile application user data associated with a mobile application on a user device associated with a user; communicating, with at least one processor, a payment request message based on receiving the mobile application user data, wherein the payment request message comprises the mobile application user data; generating, with at least one processor, a payment request notification message based on receiving the payment request message; communicating, with at least one processor, the payment request notification message to the mobile application on the user device associated with the user; receiving, with at least one processor, a payment request response message, wherein the payment request response message comprises payment method data communicated by the user device independent of a short range wireless communication connection, wherein the payment method data is communicated via the mobile application; and processing, with at least one processor, at least one payment transaction involving the user and a merchant using the payment method data communicated via the mobile application.

Clause 22: The method of clause 21, wherein the mobile application is associated with a payment gateway system.

Clause 23: The method of clauses 21 or 22, wherein the mobile application is associated with an electronic wallet provider system.

Clause 24: The method of any of clauses 21-23, wherein the short range wireless communication connection is a short range wireless communication connection between the user device associated with the user and a point-of-sale device associated with the merchant.

Clause 25: The method of any of clauses 21-24, further comprising receiving a message comprising data associated with a result of processing the at least one payment transaction.

Clause 26: The method of any of clauses 21-25, wherein the mobile application user data comprises payment gateway user account data associated with an identifier for a user account of the user associated with a payment gateway system.

Clause 27: The method of any of clauses 21-26, wherein the payment request message comprises transaction data associated with the at least one payment transaction, and wherein generating the payment request notification message comprises: generating the payment request notification message based on the transaction data associated with the at least one payment transaction, wherein the payment request notification message comprises the transaction data.

Clause 28: The method of any of clauses 21-27, wherein communicating the payment request notification message to the user device associated with the user comprises: communicating the payment request notification message to the user device associated with the user based on the mobile application user data.

Clause 29: The method of any of clauses 21-28, wherein the mobile application is associated with a payment gateway system and wherein the payment method data is communicated by the user device to the payment gateway system via the mobile application associated with the payment gateway system.

Clause 30: The method of any of clauses 21-29, further comprising: determining device identifier data associated with a device identifier of the user device associated with the user, wherein communicating the payment request notification message to the mobile application comprises: communicating the payment request notification message to the mobile application based on the device identifier data.

Clause 31: A system for conducting a payment transaction, the system comprising: at least one processor programmed or configured to: receive mobile application user data associated with a mobile application on a user device associated with a user; communicate a payment request message based on receiving the mobile application user data, wherein the payment request message comprises the mobile application user data; generate a payment request notification message; communicate the payment request notification message to the mobile application on the user device associated with the user based on the mobile application user data; receive a payment request response message, wherein the payment request response message comprises payment method data communicated independent of a short range wireless communication connection, wherein the payment method data is communicated via the mobile application; and process at least one payment transaction involving the user and a merchant using the payment method data received via the mobile application.

Clause 32: The system of clause 31, wherein the user device comprises a mobile device, wherein the payment method data is communicated by the mobile device to a payment gateway system via the mobile application, and wherein the mobile application is associated with the payment gateway system.

Clause 33: The system of clauses 31 or 32, wherein the mobile application is associated with a payment gateway system.

Clause 34: The system of any of clauses 31-33, wherein the mobile application user data comprises payment gateway user account data, wherein the at least one processor comprises a processor of the payment gateway system, and the processor of the payment gateway system is programmed or configured to: receive the payment request message; generate the payment request notification message based on receiving the payment request message; and communicate the payment request notification message to the mobile application on the user device associated with the user based on the payment gateway user account data.

Clause 35: The system of any of clauses 31-34, wherein the mobile application is associated with an electronic wallet provider system.

Clause 36: The system of any of clauses 13-35, wherein the mobile application user data comprises electronic wallet application user account data, wherein the at least one processor comprises a processor of the electronic wallet provider system, and the processor of the electronic wallet provider system is programmed or configured to: receive the payment request message; generate the payment request notification message based on receiving the payment request message; and communicate the payment request notification message to the mobile application on the user device associated with the user based on the electronic wallet application user account data.

Clause 37: The system of any of clauses 31-36, wherein the at least one processor is programmed or configured to: receive a payment processing result message comprising data associated with a result of processing the at least one payment transaction.

Clause 38: A computer program product for conducting a payment transaction, the computer program product comprising at least one non-transitory computer-readable medium including one or more instructions that, when executed by at least one processor, cause the at least one processor to: receive mobile application user data associated with a mobile application on a user device associated with a user; communicate a payment request message based on receiving the mobile application user data, wherein the payment request message comprises the mobile application user data; generate a payment request notification message based on receiving the payment request message; communicate the payment request notification message to the mobile application on the user device associated with the user based on the mobile application user data; receive a payment request response message, wherein the payment request response message comprises payment method data communicated by the user device independent of a short range wireless communication connection, wherein the payment method data is communicated via the mobile application; and process at least one payment transaction involving the user and a merchant using the payment method data received via the mobile application.

Clause 39: The computer program product of clause 38, wherein the one or more instructions, when executed by the at least one processor, further cause the at least one processor to: determine device identifier data associated with a device identifier of the user device associated with the user, wherein the one or more instructions, that cause the at least one processor to communicate the payment request notification message to the mobile application, cause the at least one processor to: communicate the payment request notification message to the mobile application based on the device identifier data.

Clause 40: The computer program product of clauses 38 or 39, wherein the one or more instructions, when executed by the at least one processor, further cause the at least one processor to: receive a payment processing result message comprising data associated with a result of processing the at least one payment transaction.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a,” “an,” and “the” include plural referents unless the context clearly dictates otherwise.

### BRIEF DESCRIPTION OF THE DRAWINGS

Additional advantages and details of the invention are explained in greater detail below with reference to the exemplary embodiments that are illustrated in the accompanying schematic figures, in which:

FIG. 1 is a diagram of a non-limiting embodiment of an environment in which systems, apparatus, and/or methods, described herein, may implemented according to the principles of the present invention;

FIG. 2 is a diagram of a non-limiting embodiment of components of one or more devices of FIG. 1;

FIG. 3 is a flowchart of a non-limiting embodiment of a process for conducting a payment transaction according to the principles of the present invention;

FIG. 4 is a flowchart of a non-limiting embodiment of a process for conducting a payment transaction according to the principles of the present invention;

FIGS. 5A-5B are diagrams of an implementation of a non-limiting embodiment of the process shown in FIG. 4;

FIGS. 6A-6B are non-limiting embodiments of user interface screens displayed by a user device as part of an implementation of the non-limiting embodiment of the process shown in FIG. 4;

FIG. 7 is a flowchart of a non-limiting embodiment of a process for conducting a payment transaction according to the principles of the present invention;

FIGS. 8A-8B are diagrams of an implementation of a non-limiting embodiment of the process shown in FIG. 7; and

FIGS. 9A-9C are diagrams of an implementation of a non-limiting embodiment of the process shown in FIG. 7.

### DESCRIPTION OF THE INVENTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects of the embodiments disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items, and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least in partially on” unless explicitly stated otherwise.

As used herein, the terms “communication” and “communicate” may refer to the reception, receipt, transmission, transfer, provision, and/or the like, of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments, a message may refer to a network packet (e.g., a data packet, and/or the like) that includes data. It will be appreciated that numerous other arrangements are possible.

As used herein, the terms “issuer institution,” “portable financial device issuer,” “issuer,” or “issuer bank” may refer to one or more entities that provide accounts to customers for conducting transactions (e.g., payment transactions), such as initiating credit and/or debit payments. For example, an issuer institution may provide an account identifier, such as a personal account number (PAN), to a customer that uniquely identifies one or more accounts associated with that customer. The account identifier may be embodied on a portable financial device, such as a physical financial instrument, e.g., a payment card, and/or may be electronic and used for electronic payments. The terms “issuer institution” and “issuer institution system” may also refer to one or more computer systems operated by or on behalf of an issuer institution, such as a server computer executing one or more software applications. For example, an issuer institution system may include one or more authorization servers for authorizing a transaction.

As used herein, the term “account identifier” may include one or more PANs, tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes. An issuer institution may be associated with a bank identification number (BIN) that uniquely identifies it.

As used herein, the term “account identifier” may include one or more types of identifiers associated with a user account (e.g., a PAN, a primary account number, a card number, a payment card number, a token, and/or the like). In some non-limiting embodiments, an issuer institution may provide an account identifier (e.g., a PAN, a token, and/or the like) to a user that uniquely identifies one or more accounts associated with that user. The account identifier may be embodied on a physical financial instrument (e.g., a portable financial instrument, a payment card, a credit card, a debit card, and/or the like) and/or may be electronic information communicated to the user that the user may use for electronic payments. In some non-limiting embodiments, the account identifier may be an original account identifier, where the original account identifier was provided to a user at the creation of the account associated with the account identifier. In some non-limiting embodiments, the account identifier may be an account identifier (e.g., a supplemental account identifier) that is provided to a user after the original account identifier was provided to the user. For example, if the original account identifier is forgotten, stolen, and/or the like, a supplemental account identifier may be provided to the user. In some non-limiting embodiments, an account identifier may be directly or indirectly associated with an issuer institution such that an account identifier may be a token that maps to a PAN or other type of identifier. Account identifiers may be alphanumeric, any combination of characters and/or symbols, and/or the like.

As used herein, the term “token” may refer to an identifier that is used as a substitute or replacement identifier for an account identifier, such as a PAN. Tokens may be associated with a PAN or other account identifiers in one or more data structures such that they can be used to conduct a transaction (e.g., a payment transaction) without directly using the account identifier, such as a PAN. In some examples, an account identifier, such as a PAN, may be associated with a plurality of tokens for different uses or different purposes.

As used herein, the term “merchant” may refer to one or more entities (e.g., operators of retail businesses that provide goods and/or services, and/or access to goods and/or services, to a user (e.g., a customer, a consumer, a customer of the merchant, and/or the like) based on a transaction (e.g., a payment transaction)). As used herein “merchant system” may refer to one or more computer systems operated by or on behalf of a merchant, such as a server computer executing one or more software applications. As used herein, the term “product” may refer to one or more goods and/or services offered by a merchant.

As used herein, a “point-of-sale (POS) device” may refer to one or more devices, which may be used by a merchant to initiate transactions (e.g., a payment transaction), engage in transactions, and/or process transactions. For example, a POS device may include one or more computers, peripheral devices, card readers, near-field communication (NFC) receivers, radio frequency identification (RFID) receivers, and/or other contactless transceivers or receivers, contact-based receivers, payment terminals, computers, servers, input devices, and/or the like.

As used herein, the term “transaction service provider” may refer to an entity that receives transaction authorization requests from merchants or other entities and provides guarantees of payment, in some cases through an agreement between the transaction service provider and the issuer institution. In some non-limiting embodiments, a transaction service provider may include a credit card company, a debit card company, and/or the like. As used herein, the term “transaction service provider system” may also refer to one or more computer systems operated by or on behalf of a transaction service provider, such as a transaction processing server executing one or more software applications. A transaction processing server may include one or more processors and, in some non-limiting embodiments, may be operated by or on behalf of a transaction service provider.

As used herein, the term “acquirer” may refer to an entity licensed by the transaction service provider and approved by the transaction service provider to originate transactions (e.g., payment transactions) using a portable financial device associated with the transaction service provider. As used herein, the term “acquirer system” may also refer to one or more computer systems, computer devices, and/or the like operated by or on behalf of an acquirer. The transactions the acquirer may originate may include payment transactions (e.g., purchases, original credit transactions (OCTs), account funding transactions (AFTs), and/or the like). In some non-limiting embodiments, the acquirer may be authorized by the transaction service provider to assign merchant or service providers to originate transactions using a portable financial device of the transaction service provider. The acquirer may contract with payment facilitators to enable the payment facilitators to sponsor merchants. The acquirer may monitor compliance of the payment facilitators in accordance with regulations of the transaction service provider. The acquirer may conduct due diligence of the payment facilitators and ensure proper due diligence occurs before signing a sponsored merchant. The acquirer may be liable for all transaction service provider programs that the acquirer operates or sponsors. The acquirer may be responsible for the acts of the acquirer's payment facilitators, merchants that are sponsored by an acquirer's payment facilitator, and/or the like. In some non-limiting embodiments, an acquirer may be a financial institution, such as a bank.

As used herein, the terms “electronic wallet,” “electronic wallet mobile application,” and “digital wallet” may refer to one or more electronic devices and/or one or more software applications configured to initiate and/or conduct transactions (e.g., payment transactions, electronic payment transactions, and/or the like). For example, an electronic wallet may include a user device (e.g., a mobile device) executing an application program and server-side software and/or databases for maintaining and providing transaction data to the user device. As used herein, the term “electronic wallet provider” may include an entity that provides and/or maintains an electronic wallet and/or an electronic wallet mobile application for a user (e.g., a customer). Examples of an electronic wallet provider include, but are not limited to, Google Wallet™, Android Pay®, Apple Pay®, and Samsung Pay®. In some non-limiting examples, a financial institution (e.g., an issuer institution) may be an electronic wallet provider. As used herein, the term “electronic wallet provider system” may refer to one or more computer systems, computer devices, servers, groups of servers, and/or the like operated by or on behalf of an electronic wallet provider.

As used herein, the term “portable financial device” may refer to a payment card (e.g., a credit or debit card), a gift card, a smartcard, smart media, a payroll card, a healthcare card, a wrist band, a machine-readable medium containing account information, a keychain device or fob, an RFID transponder, a retailer discount or loyalty card, a cellular phone, an electronic wallet mobile application, a personal digital assistant (PDA), a pager, a security card, a computer, an access card, a wireless terminal, a transponder, and/or the like. In some non-limiting embodiments, the portable financial device may include volatile or non-volatile memory to store information (e.g., an account identifier, a name of the account holder, and/or the like).

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like, operated by or on behalf of a payment gateway and/or to a payment gateway itself. The term “payment gateway mobile application” may refer to one or more electronic devices and/or one or more software applications configured to provide payment services for transactions (e.g., payment transactions, electronic payment transactions, and/or the like).

As used herein, the terms “client” and “client device” may refer to one or more client-side devices or systems (e.g., remote from a transaction service provider) used to initiate or facilitate a transaction (e.g., a payment transaction). As an example, a “client device” may refer to one or more POS devices used by a merchant, one or more acquirer host computers used by an acquirer, one or more mobile devices used by a user, and/or the like. In some non-limiting embodiments, a client device may be an electronic device configured to communicate with one or more networks and initiate or facilitate transactions. For example, a client device may include one or more computers, portable computers, laptop computers, tablet computers, mobile devices, cellular phones, wearable devices (e.g., watches, glasses, lenses, clothing, and/or the like), PDAs, and/or the like. Moreover, a “client” may also refer to an entity (e.g., a merchant, an acquirer, and/or the like) that owns, utilizes, and/or operates a client device for initiating transactions (e.g., for initiating transactions with a transaction service provider).

As used herein, the term “server” may refer to one or more computing devices (e.g., processors, storage devices, similar computer components, and/or the like) that communicate with client devices and/or other computing devices over a network (e.g., a public network, the Internet, a private network, and/or the like) and, in some examples, facilitate communication among other servers and/or client devices. It will be appreciated that various other arrangements are possible. As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different server or processor, and/or a combination of servers and/or processors. For example, as used in the specification and the claims, a first server or a first processor that is recited as performing a first step or a first function may refer to the same or different server or the same or different processor recited as performing a second step or a second function.

Non-limiting embodiments of the present invention may allow a payment transaction may be conducted based on payment method data being communicated independent of a short range wireless communication connection. For example, a transaction may be conducted based where payment method data is communicated by a user device and/or payment method data is received by a merchant system independent of a short range wireless communication connection. In such an example, the user device and/or the merchant system (e.g., a POS device associated with the merchant system) may not have the capability to communicate and/or receive information via a short range wireless communication connection. The user device and/or the merchant system may not include components that allow for the establishment of an NFC communication connection, an RFID communication connection, a Bluetooth® communication connection, and/or the like, between the user device and the merchant system. In this manner, non-limiting embodiments of the present invention enable the use of existing systems, devices, and/or the like, that may not have the capability to communicate and/or receive information via a short range wireless communication connection.

In addition, by communicating payment method data independent of a short range wireless communication according to non-limiting embodiments of the present invention, it is not necessary for the user device and/or the merchant system to be capable of communicating payment method data via a short range wireless communication connection to conduct a payment transaction involving the exchange of electronically stored payment method data. For example, a user associated with the user device may be able to conduct a payment transaction with a merchant associated with the merchant system using an account identifier that is stored electronically (e.g., using an account identifier without a physical financial instrument, such as a credit card) on the user device by communicating the account identifier and/or data associated with the account identifier independent of a short range wireless communication connection. In such an example, the merchant system may receive the account identifier and/or data associated with the account identifier independent of a short range wireless communication connection.

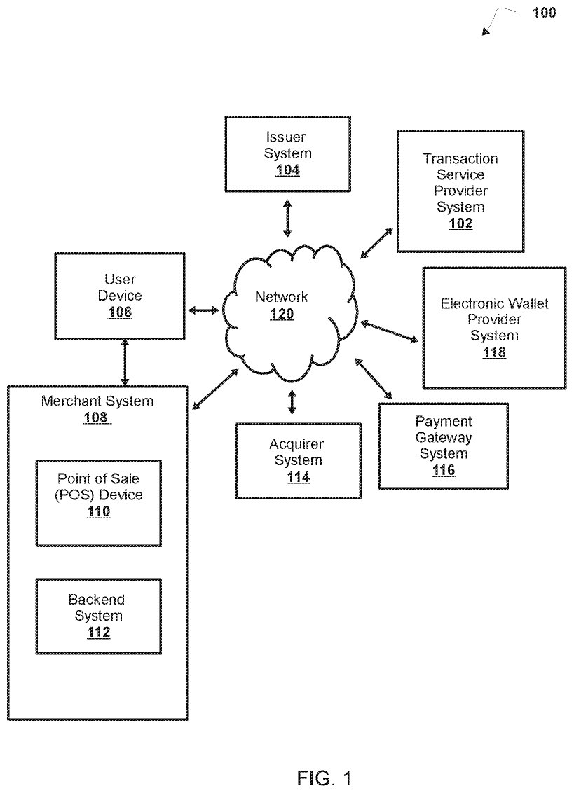

Referring now to FIG. 1, FIG. 1 is a diagram of a non-limiting embodiment of an environment 100 in which systems, apparatus, and/or methods, as described herein, may be implemented. As shown in FIG. 1, environment 100 includes transaction service provider system 102, issuer system 104, user device 106, merchant system 108, acquirer system 114, payment gateway system 116, electronic wallet provider system 118, and network 120. As further shown in FIG. 1, merchant system 108 may include POS device 110 and backend system 112.

Transaction service provider system 102 may include one or more devices capable of receiving information from and/or communicating information to issuer system 104, user device 106, merchant system 108, acquirer system 114, payment gateway system 116, and/or electronic wallet provider system 118, via network 120. For example, transaction service provider system 102 may include one or more computing devices, such as a server, a group of servers, and/or the like. In some non-limiting embodiments, transaction service provider system 102 may be associated with an entity (e.g., a transaction service provider) that operates a credit card network and that processes payments for credit accounts, debit accounts, credit cards, debit cards, and/or the like.

Issuer system 104 may include one or more devices capable of receiving information from and/or communicating information to transaction service provider system 102, user device 106, merchant system 108, acquirer system 114, payment gateway system 116, and/or electronic wallet provider system 118, via network 120. For example, issuer system 104 may include one or more computing devices, such as a server, a group of servers, and/or the like. In some non-limiting embodiments, the issuer system 104 may be associated with an issuer institution as described herein. In some non-limiting embodiments, issuer system 104 may be associated with an issuer institution that issued a credit account, debit account, credit card, debit card, and/or the like to a user associated with user device 106.

User device 106 may include one or more devices capable of receiving information from and/or communicating information to transaction service provider system 102, issuer system 104, merchant system 108, acquirer system 114, payment gateway system 116, and/or electronic wallet provider system 118, via network 120. For example, user device 106 may include a client device. In some non-limiting embodiments, user device 106 may or may not be capable of receiving information (e.g., from merchant system 108) via a short range wireless communication connection (e.g., an NFC communication connection, an RFID communication connection, a Bluetooth® communication connection, and/or the like), and/or communicating information (e.g., to merchant system 108) via a short range wireless communication connection. For example, user device 106 may not be capable of receiving data from merchant system 108 via an NFC communication connection and/or communicating data to merchant system 108 via an NFC communication connection. In some non-limiting embodiments, user device 106 may be capable of conducting (e.g., engaging in) a payment transaction with merchant system 108, where user device 106 may receive data (e.g., payment method data) and/or communicate data (e.g., payment method data) independent of a short range wireless communication connection.

Merchant system 108 may include one or more devices capable of receiving information from and/or communicating information to transaction service provider system 102, issuer system 104, user device 106, acquirer system 114, payment gateway system 116, and/or electronic wallet provider system 118, via network 120. For example, merchant system 108 may include a computing device, a server, a group of servers, a client device, a group of client devices, and/or the like. In some non-limiting embodiments, merchant system 108 may be associated with a merchant as described herein. In some non-limiting embodiments, merchant system 108 may include one or more user devices 106. For example, merchant system 108 may include user device 106 that allows a merchant associated with merchant system 108 to receive information from and/or communicate information to transaction service provider system 102.

In some non-limiting embodiments, merchant system 108 may be capable of being used by a merchant to initiate, engage in, and/or conduct a payment transaction with a user (e.g., a customer, a consumer, and/or the like) associated with user device 106. For example, merchant system 108 may include one or more computers, servers, input devices, payment terminals, magnetic stripe card readers, chip card readers, contactless transceivers, contactless receivers, NFC receivers, RFID receivers, contact-based receivers, and/or other similar devices. In some non-limiting embodiments, merchant system 108 may or may not include a device capable of receiving information from user device 106 via a short range wireless communication connection (e.g., a communication connection that uses NFC protocol, a communication connection that uses RFID, a communication connection that uses a Bluetooth® wireless technology standard, and/or the like), and/or communicating information to user device 106 via a short range wireless communication connection. For example, merchant system 108 may not include a device capable of receiving data from user device 106 via an NFC communication connection and/or communicating data to user device 106 via an NFC communication connection. Additionally, user device 106 may not include a device capable of receiving data from merchant system 108 via an NFC communication connection and/or communicating data to merchant system 108 via an NFC communication connection.

Merchant system 108 may include POS device 110 and backend system 112. In some non-limiting embodiments, POS device 110 may include a POS terminal (e.g., a POS terminal located at a location of a merchant) and/or an electronic device that performs the functions of a POS terminal. In some non-limiting embodiments, backend system 112 may include a computing device, a server, a group of servers, and/or the like. In some non-limiting embodiments, POS device 110 and/or backend system 112 may be capable of receiving information from and/or communicating information to transaction service provider system 102, issuer system 104, user device 106, acquirer system 114, payment gateway system 116, and/or electronic wallet provider system 118, via network 120. In some non-limiting embodiments, POS device 110 and backend system 112 may be capable of receiving information from and/or communicating information to each other. For example, POS device 110 and backend system 112 may be capable of receiving information from and/or communicating information to each other via a network (e.g., network 120). In some non-limiting embodiments, backend system 112 may be separate from merchant system 108. For example, backend system 112 may be associated with transaction service provider system 102, issuer system 104, acquirer system 114, payment gateway system 116, and/or electronic wallet provider system 118.

Acquirer system 114 may include one or more devices capable of receiving information from and/or communicating information to transaction service provider system 102, issuer system 104, user device 106, merchant system 108, payment gateway system 116, and/or electronic wallet provider system 118, via network 120. For example, acquirer system 114 may include a computing device, a server, a group of servers, and/or the like. In some non-limiting embodiments, acquirer system 114 may be associated with an acquirer as described herein.

Payment gateway system 116 may include one or more devices capable of receiving information from and/or communicating information to transaction service provider system 102, issuer system 104, user device 106, merchant system 108, acquirer system 114, and/or electronic wallet provider system 118, via network 120. For example, payment gateway system 116 may include one or more computing devices, such as a server, a group of servers, and/or the like. In some non-limiting embodiments, payment gateway system 116 may be associated with a payment gateway as described herein.

Electronic wallet provider system 118 may include one or more devices capable of receiving information from and/or communicating information to transaction service provider system 102, issuer system 104, user device 106, merchant system 108, acquirer system 114, and/or payment gateway system 116, via network 120. For example, electronic wallet provider system 118 may include one or more computing devices, such as a server, a group of servers, and/or the like. In some non-limiting embodiments, electronic wallet provider system 118 may be associated with an electronic wallet provider as described herein.

Network 120 may include one or more wired and/or wireless networks. For example, network 120 may include a cellular network (e.g., a long-term evolution (LTE) network, a third generation (3G) network, a fourth generation (4G) network, a code division multiple access (CDMA) network, etc.), a public land mobile network (PLMN), a local area network (LAN), a wide area network (WAN), a metropolitan area network (MAN), a telephone network (e.g., a public switched telephone network (PSTN)), a private network (e.g., a private network associated with a transaction service provider), an ad hoc network, an intranet, the Internet, a fiber optic-based network, a cloud computing network, and/or the like, and/or a combination of these or other types of networks.

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices. Additionally, or alternatively, a set of systems (e.g., one or more systems) or a set of devices (e.g., one or more devices) of environment 100 may perform one or more functions described as being performed by another set of systems or another set of devices of environment 100.

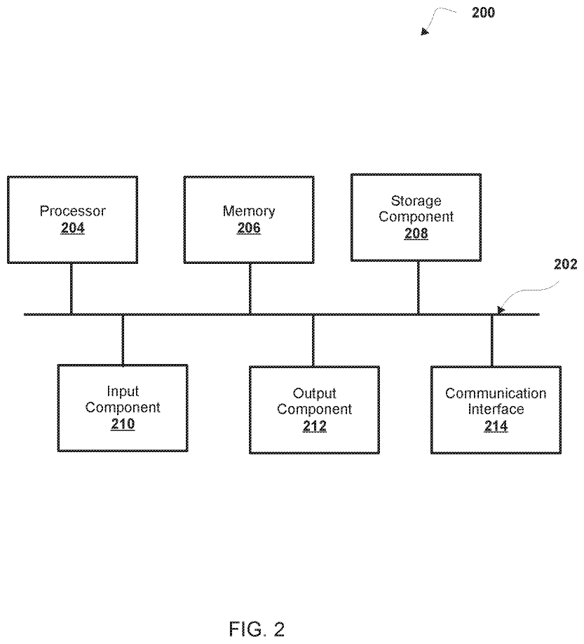

Referring now to FIG. 2, FIG. 2 is a diagram of example components of a device 200. Device 200 may correspond to transaction service provider system 102, issuer system 104, user device 106, merchant system 108, POS device 110, backend system 112, acquirer system 114, payment gateway system 116, and/or electronic wallet provider system 118, and/or one or more devices of transaction service provider system 102, issuer system 104, user device 106, merchant system 108, backend system 112, acquirer system 114, payment gateway system 116, and/or electronic wallet provider system 118. In some non-limiting embodiments, transaction service provider system 102, issuer system 104, user device 106, merchant system 108, POS device 110, backend system 112, acquirer system 114, payment gateway system 116, and/or electronic wallet provider system 118 may include at least one device 200 and/or at least one component of device 200. As shown in FIG. 2, device 200 may include bus 202, processor 204, memory 206, storage component 208, input component 210, output component 212, and communication interface 214.

Bus 202 may include a component that permits communication among the components of device 200. In some non-limiting embodiments, processor 204 may be implemented in hardware, firmware, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.), and/or the like, which can be programmed to perform a function. Memory 206 may include random access memory (RAM), read only memory (ROM), and/or another type of dynamic or static storage device (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, etc.). Additionally, or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a receiver and transmitter that are separate, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software.

The number and arrangement of components shown in FIG. 2 are provided as an example. In some non-limiting embodiments, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

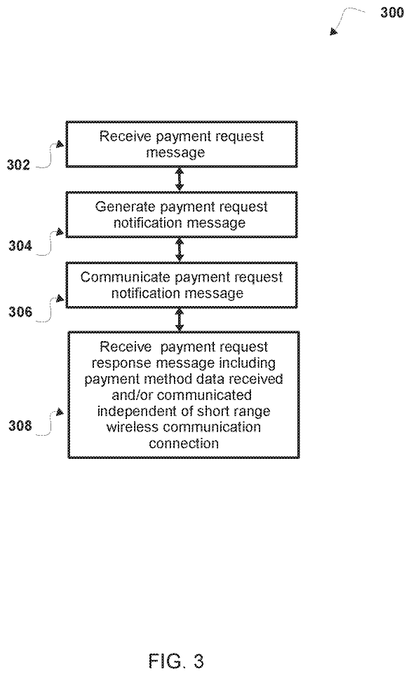

Referring now to FIG. 3, FIG. 3 is a flowchart of a non-limiting embodiment of a process 300 for conducting a payment transaction. In some non-limiting embodiments, one or more of the steps of process 300 may be performed (e.g., completely, partially, etc.) by payment gateway system 116 and/or electronic wallet provider system 118. In some non-limiting embodiments, one or more of the steps of process 300 may be performed (e.g., completely, partially, etc.) by another system, another device, another group of systems, or another group of devices, separate from or including payment gateway system 116 and/or electronic wallet provider system 118, such as transaction service provider system 102 (e.g., one or more devices of transaction service provider system 102), issuer system 104 (e.g., one or more devices of issuer system 104), user device 106, merchant system 108 (e.g., one or more devices of merchant system 108), or acquirer system 114 (e.g., one or more devices of acquirer system 114).

As shown in FIG. 3, at step 302, process 300 includes receiving a payment request message. For example, payment gateway system 116 and/or electronic wallet provider system 118 may receive a payment request message from merchant system 108. In some non-limiting embodiments, payment gateway system 116 and/or electronic wallet provider system 118 may receive the payment request message from merchant system 108 as part of a payment transaction involving a merchant associated with merchant system 108 and a user associated with user device 106. For example, payment gateway system 116 and/or electronic wallet provider system 118 may receive the payment request message from merchant system 108 before processing the payment transaction.

In some non-limiting embodiments, payment gateway system 116 and/or electronic wallet provider system 118 may receive the payment request message from merchant system 108 (e.g., backend system 112 of merchant system 108) after merchant system 108 receives data from the user involved in a payment transaction with the merchant associated with merchant system 108. For example, payment gateway system 116 and/or electronic wallet provider system 118 may receive the payment request message from merchant system 108 after merchant system 108 receives payment gateway communication data and/or mobile application user data (e.g., payment gateway user account data and/or electronic wallet application user data) from the user via a user device (e.g., user device 106) and/or via a POS device (e.g., POS device 110) associated with merchant system 108.

In some non-limiting embodiments, merchant system 108 may receive payment gateway communication data and/or mobile application user data (e.g., payment gateway user account data and/or electronic wallet application user data) from a user via POS device 110 of merchant system 108 after the user selects a payment process option (e.g., via a user selectable element associated with a payment process option, and/or the like) displayed by POS device 110. For example, POS device 110 may display a plurality of payment process options on an output component (e.g., a display) of POS device 110 and POS device 110 may receive a selection from the user of one of the plurality of payment process options. POS device 110 may receive the payment gateway communication data or the mobile application user data (e.g., payment gateway user account data and/or electronic wallet application user data) after receiving the selection of one of the plurality of payment process options. In some non-limiting embodiments, a payment process option may include a payment process option associated with using a network resource (e.g., a website, a webpage of a website, and/or the like) of a payment gateway (e.g., payment gateway system 116) to communicate payment method data, a payment process option associated with using a mobile application of a payment gateway (e.g., payment gateway system 116) to communicate payment method data, or a payment process option associated with using a mobile application of an electronic wallet provider (e.g., electronic wallet provider system 118) to communicate payment method data. In some non-limiting embodiments, POS device 110 may receive the payment gateway communication data after the user selects a payment process option associated with using a network resource of a payment gateway to communicate payment method data. For example, the user may select the payment process option and the user may provide the payment gateway communication data to POS device 110. In some non-limiting embodiments, POS device 110 may receive the payment gateway user account data after the user selects a payment process option associated with using a mobile application of a payment gateway to communicate payment method data. For example, the user may select the payment process option and the user may provide the payment gateway user account data to POS device 110. In some non-limiting embodiments, POS device 110 may receive the electronic wallet application user data after the user selects a payment process option associated with using a mobile application of an electronic wallet provider to communicate payment method data. For example, the user may select the payment process option and the user may provide the electronic wallet application user data to POS device 110.

In some non-limiting embodiments, user device 106 (e.g., a mobile device) may display a plurality of payment process options on a display of user device 106. User device 106 may receive a selection of one of the plurality of payment process options from the user, and user device 106 may receive the payment gateway communication data and/or the mobile application user data (e.g., payment gateway user account data and/or electronic wallet application user data) from the user after receiving the selection of one of the plurality of payment process options. User device 106 may communicate the payment gateway communication data and/or the mobile application user data (e.g., payment gateway user account data and/or electronic wallet application user data) to POS device 110 and/or another component of merchant system 108.

In some non-limiting embodiments, the payment request message may include payment gateway communication data and/or mobile application user data (e.g., payment gateway user account data and/or electronic wallet application user data). Additionally or alternatively, the payment request message may include transaction data associated with a payment transaction involving a user and a merchant.

In some non-limiting embodiments, the payment gateway communication data may include communication channel type data associated with a type of communication channel. Additionally or alternatively, the payment gateway communication data may include communication channel user data associated with contact information of the user. In some non-limiting embodiments, the communication channel type data may include an identifier associated with a type of communication channel (e.g., an identifier associated with using an email address as a communication channel, an identifier associated with using a text message as a communication channel, an identifier associated with using a social media account as a communication channel, and/or the like). In some non-limiting embodiments, the communication channel user data may include the contact information of a user (e.g., a device identifier (e.g., a network address, an Internet Protocol (IP) address, a media access control (MAC) address, a phone number, and/or the like) for user device 106 associated with the user, a mobile device number of a mobile device associated with the user, an email address of an email account associated with the user, an identifier of an online account associated with the user, a user name of a social media account associated with the user, and/or the like).

In some non-limiting embodiments, the payment gateway mobile application user data may include an identifier for a user account of the user associated with a payment gateway (e.g., an identifier for a user account of the user associated with the payment gateway, a user name for a user account of the user associated with the payment gateway, a user identification number for a user account of the user associated with the payment gateway, an account identification number for a user account of the user associated with the payment gateway, a name of the user that identifies a user account of the user associated with the payment gateway, a device identifier for user device 106 associated with the user that identifies a user account of the user associated with the payment gateway, a mobile device number for a mobile device associated with the user that identifies a user account of the user associated with the payment gateway, an email address of the user that identifies a user account of the user associated with the payment gateway, an identifier of the user for an online account that identifies a user account of the user associated with the payment gateway, a user name of the user for a social media account that identifies a user account of the user associated with the payment gateway, and/or the like).

In some non-limiting embodiments, the electronic wallet application user data may include electronic wallet provider identification data associated with an electronic wallet provider (e.g., an identifier associated with an electronic wallet provider, a name of an electronic wallet provider, and/or the like). Additionally or alternatively, the electronic wallet application user data may include electronic wallet application user account data. In some non-limiting embodiments, the electronic wallet user account data may include an identifier for a user account of the user associated with an electronic wallet provider (e.g., an identifier for a user account of the user associated with the electronic wallet provider, a user name for a user account of the user associated with the electronic wallet provider, a user identification number for a user account of the user associated with the electronic wallet provider, an account identification number for a user account of the user associated with the electronic wallet provider, a name of the user that identifies a user account of the user associated with the electronic wallet provider, a device identifier for user device 106 associated with the user that identifies a user account of the user associated with the electronic wallet provider, a mobile device number for a mobile device associated with the user that identifies a user account of the user associated with the electronic wallet provider, an email address of the user that identifies a user account of the user associated with the electronic wallet provider, a user name of the user for a social media account that identifies a user account of the user associated with the electronic wallet provider, and/or the like).

In some non-limiting embodiments, the transaction data associated with the payment transaction may include transaction amount data associated with a transaction amount of the payment transaction (e.g., a transaction amount, an overall transaction amount, a cost of each product involved, and/or the like), transaction identifier data associated with an identifier of the payment transaction (e.g., a reference number, a unique identifier, a transaction identifier, a transaction ID, a unique transaction identifier (UTI), a merchant identifier, a merchant order identifier, a merchant order identification number, a POS device identifier, and/or the like), transaction product data associated with a product involved in the payment transaction (e.g., a name of the product, a name of a type of product, a stock keeping unit (SKU) number associated with a product, a merchant code associated with a product, and/or the like), transaction time data associated with a time of the payment transaction (e.g., a time of day, a day of the week, a day of a month, a month of a year, a predetermined time of day segment such as morning, afternoon, evening, night, and/or the like, a predetermined day of the week segment such as weekday, weekend, and/or the like, a predetermined segment of a year such as first quarter, second quarter, and/or the like, and/or the like), transaction type data associated with a transaction type of the payment transaction (e.g., an online transaction, a card present transaction, a face-to-face transaction, and/or the like), and/or the like.

In some non-limiting embodiments, backend system 112 of merchant system 108 may generate the payment request message. For example, backend system 112 may receive the payment gateway communication data, the mobile application user data (e.g., the payment gateway user account data and/or the electronic wallet application user data), and/or the transaction data from POS device 110 and backend system 112 may generate the payment request message based on receiving the payment gateway communication data, the mobile application user data, and/or the transaction data from POS device 110. In some non-limiting embodiments, POS device 110 of merchant system 108 may generate the payment request message. For example, POS device 110 may generate the payment request message based on receiving the payment gateway communication data and/or the mobile application user data from the user.

In some non-limiting embodiments, merchant system 108 (e.g., POS device 110 of merchant system 108 and/or backend system 112 of merchant system 108) may communicate the payment request message. For example, POS device 110 of merchant system 108 or backend system 112 of merchant system 108 may communicate the payment request message based on generating the payment request message. In some non-limiting embodiments, merchant system 108 may communicate the payment request message to user device 106 (e.g., a mobile device) associated with the user, payment gateway system 116, and/or electronic wallet provider system 118. For example, merchant system 108 may communicate the payment request message to user device 106 using a communication channel specified by the user associated with the mobile device. In another example, merchant system 108 may communicate the payment request message to user device 106 associated with the user, payment gateway system 116, and/or electronic wallet provider system 118 using a unicast addressing method, a broadcast addressing method, multicast addressing method, an anycast addressing method, a geocast addressing method, and/or the like.

In some non-limiting embodiments, POS device 110 may communicate the payment request message to backend system 112. For example, POS device 110 may generate the payment request message, where the payment request message includes payment gateway communication data, and POS device 110 may communicate the payment request message to the backend system 112. Backend system 112 may receive the payment request message from POS device 110.

In some non-limiting embodiments, user device 106, payment gateway system 116, and/or electronic wallet provider system 118 may receive the payment request message from merchant system 108. For example, user device 106, payment gateway system 116, and/or electronic wallet provider system 118 may receive the payment request message after the payment request message is communicated by POS device 110 and/or backend system 112.

As further shown in FIG. 3, at step 304, process 300 includes generating a payment request notification message. For example, payment gateway system 116 and/or electronic wallet provider system 118 may generate a payment request notification message based on receiving the payment request message. In some non-limiting embodiments, payment gateway system 116 and/or electronic wallet provider system 118 may generate the payment request notification message based on data included in the payment request message. For example, the payment request notification message may include transaction data (e.g., transaction amount data and/or the like), where the transaction data is included in the payment request message.

In some non-limiting embodiments, backend system 112 may generate a payment request notification message based on receiving a payment request message from POS device 110. For example, POS device 110 may communicate the payment request message to backend system 112 and backend system 112 may receive the payment request message from POS device 110. Backend system 112 may generate the payment request notification message based on the payment request message. For example, the payment request notification message generated by backend system 112 may include the payment request message, payment gateway communication data included in the payment request message from POS device 110, and/or transaction data included in the payment request message from POS device 110.

As further shown in FIG. 3, at step 306, process 300 includes communicating the payment request notification message. For example, payment gateway system 116, electronic wallet provider system 118, and/or backend system 112 may communicate the payment request notification message to user device 106 (e.g., a mobile device) associated with the user involved in the payment transaction with the merchant. In some non-limiting embodiments, payment gateway system 116, electronic wallet provider system 118, and/or backend system 112 may communicate the payment request notification message to user device 106 associated with the user based on generating the payment request notification message.

In some non-limiting embodiments, user device 106 may display the payment request notification message and/or data associated with the payment request notification message (e.g., transaction data included in the payment request notification message). For example, user device 106 may display the data associated with the payment request notification message based on receiving the payment request notification message.

As further shown in FIG. 3, at step 308, process 300 includes receiving a payment request response message including payment method data received and/or communicated independent of a short range wireless communication connection. For example, payment gateway system 116 and/or electronic wallet provider system 118 may receive a payment request response message that includes payment method data received by user device 106, where the payment method data may be received by and/or communicated by user device 106 independent of a short range wireless communication connection (e.g., independent of a short range wireless communication connection that uses NFC protocol, and/or the like). In some non-limiting embodiments, merchant system 108 may not include a device capable of receiving data from user device 106 via a short range wireless communication connection and/or communicating data to user device 106 via a short range wireless communication connection. Additionally, user device 106 may not include a device capable of receiving data from merchant system 108 via a short range wireless communication connection and/or communicating data to merchant system 108 via a short range wireless communication connection.

In some non-limiting embodiments, user device 106 may communicate the payment method data after receiving the payment request notification message. For example, user device 106 may receive the payment request notification message, the user of user device 106 may provide payment method data as an input to user device 106, and user device 106 may communicate the payment method data, independent of a short range wireless communication connection (e.g., a short range wireless communication connection between POS device 110 and user device 106). In some non-limiting embodiments, user device 106 may communicate the payment method data to backend system 112, payment gateway system 116, and/or electronic wallet provider system 118. Backend system 112, payment gateway system 116, and/or electronic wallet provider system 118 may communicate the payment request response message including the payment method data based on receiving the payment method data from user device 106.

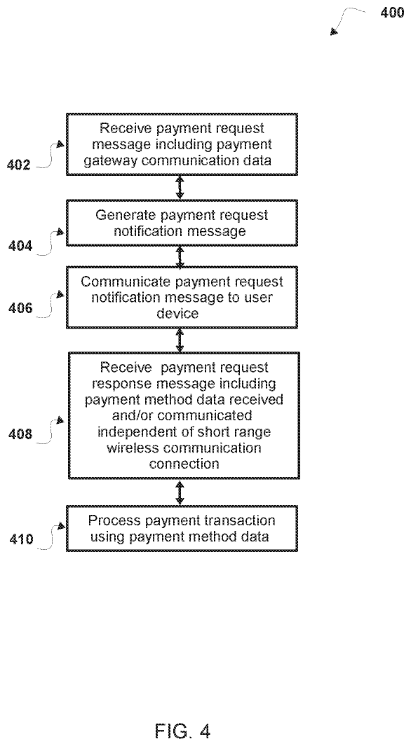

Referring now to FIG. 4, FIG. 4 is a flowchart of a non-limiting embodiment of a process 400 for conducting a payment transaction. In some non-limiting embodiments, one or more of the steps of process 400 may be performed (e.g., completely, partially, etc.) by POS device 110, backend system 112, and/or payment gateway system 116. In some non-limiting embodiments, one or more of the steps of process 400 may be performed (e.g., completely, partially, etc.) by another system, another device, another group of systems, or another group of devices, separate from or including POS device 110, backend system 112, and/or payment gateway system 116, such as transaction service provider system 102 (e.g., one or more devices of transaction service provider system 102), issuer system 104 (e.g., one or more devices of issuer system 104), user device 106, merchant system 108 (e.g., one or more devices of merchant system 108, POS device 110, and/or backend system 112), acquirer system 114 (e.g., one or more devices of acquirer system 114), or electronic wallet provider system 118 (e.g., one or more devices of electronic wallet provider system 118).

As shown in FIG. 4, at step 402, process 400 includes receiving a payment request message including payment gateway communication data. For example, backend system 112 may receive the payment request message from POS device 110. In some non-limiting embodiments, backend system 112 may receive the payment request message from POS device 110 as part of a payment transaction involving a merchant associated with merchant system 108 and a user associated with user device 106. For example, backend system 112 may receive the payment request message from POS device 110 as part of the payment transaction before the payment transaction is processed.

In some non-limiting embodiments, backend system 112 may receive the payment request message after POS device 110 receives data (e.g., payment gateway communication data, communication channel type data, and/or communication channel user data) from the user involved in a payment transaction with the merchant associated with merchant system 108. For example, backend system 112 may receive the payment request message from POS device 110 after POS device 110 receives the payment gateway communication data (e.g., communication channel type data and/or communication channel user data) from the user. POS device 110 may receive the payment gateway communication data from the user via an input component of POS device 110.

In some non-limiting embodiments, POS device 110 may receive the payment gateway communication data after the user selects a payment process option associated with using a network resource (e.g., a webpage, a website, and/or the like) of a payment gateway to communicate payment method data, where the payment process option is displayed by POS device 110. For example, POS device 110 may display a plurality of payment process options on an output component of the POS device and POS device 110 may receive a selection from the user of the payment process option. POS device 110 may receive the payment gateway communication data after receiving the selection of the payment process option.

In some non-limiting embodiments, the user may provide communication channel type data and/or communication channel user data to POS device 110. For example, the user may provide the communication channel type data and/or the communication channel user data to POS device 110 via an input component of POS device 110. In some non-limiting embodiments, POS device 110 may receive communication channel type data after the user selects the payment process option associated with using a network resource of a payment gateway to communicate payment method data. For example, POS device 110 may display a plurality of types of communication channels. The user may select a type of communication channel (e.g., a text message communication channel) and POS device 110 may receive the communication channel type data (e.g., an identifier associated with using a text message as a communication channel) based on the user selecting the type of communication channel. In some non-limiting embodiments, the user may provide the communication channel user data to POS device 110 after POS device 110 receives the communication channel type data. For example, after the user selects a type of communication channel and POS device 110 receives the communication channel type data from the user, POS device 110 may display a field in which the user may provide the communication channel user data (e.g., a device identifier associated with user device 106, a mobile device number associated with a mobile device of the user, and/or the like). In some non-limiting embodiments, POS device 110 may display a notification (e.g., an alert, an error message, and/or the like) if the communication channel user data does not correspond to the communication channel type data. For example, if POS device 110 receives an email address as the communication channel user data after POS device 110 receives an identifier associated with using a text message as a communication channel as the communication channel type data, POS device 110 may display an alert that the communication channel user data does not correspond to the communication channel type data.

In some non-limiting embodiments, POS device 110 may generate the payment request message based on receiving the payment gateway communication data (e.g., the communication channel type data and/or the communication channel user data). For example, POS device 110 may generate the payment request message based on receiving the communication channel type data and/or the communication channel user data from the user via an input component of POS device 110. In some non-limiting embodiments, POS device 110 may communicate the payment request message based on generating the payment request message. For example, POS device 110 may communicate the payment request message to backend system 112 based on generating the payment request message.

As further shown in FIG. 4, at step 404, process 400 includes generating a payment request notification message. For example, backend system 112 may generate the payment request notification message based on receiving the payment request message from POS device 110.

In some non-limiting embodiments, backend system 112 may generate a link to a network resource (e.g., a web page, a web site, a file located on a server, and/or the like) associated with a payment gateway. For example, backend system 112 may generate a link to a web page (e.g., a link to an address (e.g., URL) of a web page, and/or the like) associated with a payment gateway. In some non-limiting embodiments, backend system 112 may generate the link based on transaction data associated with a payment transaction included in the payment request message. For example, backend system 112 may generate the link to the network resource based on transaction identifier data associated with an identifier of the payment transaction. In some non-limiting embodiments, backend system 112 may generate the link to the network resource by determining a payment gateway (e.g., payment gateway system 116) for the merchant involved in the payment transaction based on the transaction identifier data, determining a network address (e.g., an IP address and/or the like) for the network resource of the payment gateway, and generating the link so that the link includes the address for the network resource. In some non-limiting embodiments, backend system 112 may generate the link based on a merchant identifier, a merchant order identification number, a POS device identifier, and/or the like.

In some non-limiting embodiments, backend system 112 may generate the payment request notification message based on the payment request message and the link to the network resource associated with the payment gateway. For example, backend system 112 may generate the payment request notification message so that the payment request notification message includes the data (e.g., a portion of the data, all of the data, the payment gateway communication data, the communication channel type data, the communication channel user data, the transaction data, and/or the like) included in the payment request message and the link to the network resource associated with the payment gateway.

As further shown in FIG. 4, at step 406, process 400 includes communicating a payment request notification message to a user device (e.g., user device 106). For example, backend system 112 may communicate the payment request notification message to user device 106 (e.g., a mobile device) associated with the user involved in the payment transaction with the merchant associated with merchant system 108. In some non-limiting embodiments, backend system 112 may communicate the payment request notification message based on generating the payment request notification message.

In some non-limiting embodiments, backend system 112 may communicate the payment request notification message based on communication channel type data and/or communication channel user data received in a payment request message. For example, backend system 112 may communicate the payment request notification message to user device 106 using a communication channel specified by the communication channel type data in the payment request message. Additionally, backend system 112 may communicate the payment request notification message to the user (e.g., user device 106 associated with the user and/or a mobile device associated with the user) using the communication channel user data. In some non-limiting embodiments, backend system 112 may communicate the payment request notification message using a text message as a communication channel, an email address as a communication channel, a social media account as a communication channel, and/or the like, based on the communication channel type data. Additionally, the backend system 112 may communicate the payment request notification message to user device 106 via a text message to user device 106 based on the device identifier for user device 106, via an email to an email address that is accessible via user device 106, via a message to a social media account that is accessible via user device 106, and/or the like, based on the communication channel user data.

As further shown in FIG. 4, at step 408, process 400 includes receiving a payment request response message including payment method data received and/or communicated independent of a short range wireless communication connection. For example, payment gateway system 116 may receive a payment request response message including payment method data received by user device 106 and/or communicated by user device 106 independent of a short range wireless communication connection between user device 106 and merchant system 108 (e.g., POS device 110). In some non-limiting embodiments, payment gateway system 116 may receive the payment request response message based on the user providing an input (e.g., via user device 106), where the input includes payment method data for a payment transaction, to a network resource included in a payment request notification message. For example, the user associated with user device 106 may receive the payment request notification message from backend system 112. User device 106 may display a link to a network resource associated with payment gateway system 116. By the user selecting (e.g., engaging) the link to the network resource, user device 106 may display the network resource to the user. The user may provide an input to user device 106, where the input may include payment method data (e.g., an account identifier, a token, a payment card number, a credit card number, and/or the like).

In some non-limiting embodiments, user device 106 may receive the payment method data based on the user associated with user device 106 providing the payment method data in a field of the network resource independent of a short range wireless communication connection. For example, the user may provide the payment method data in the field of the network resource by inputting the account identifier into the field of the network resource, by selecting an account identifier (e.g., a token) that is stored on user device 106, by selecting an account identifier (e.g., a token) that is stored on user device 106 via a field in the network resource, and/or the like. In another example, the user may provide the payment method data (e.g., an account identifier) based on the user selecting a mobile application associated with an electronic wallet provider on user device 106. In such an example, user device 106 may provide the payment method data to the network resource via the mobile application based on an application programming interface (API) call (e.g., an API call to an electronic wallet provider system, an API call to electronic wallet provider system 118, and/or the like).

In some non-limiting embodiments, user device 106 may generate the payment request response message after receiving the payment method data from the user and user device 106 may communicate the payment request response message. For example, user device 106 may generate the payment request response message, which includes the payment method data, based on receiving the payment method data. User device 106 may communicate the payment request response message to payment gateway system 116 based on generating the payment request response message and payment gateway system 116 may receive the payment request response message.

In some non-limiting embodiments, user device 106 may receive the payment method data and communicate the payment method data to a server (e.g., a web server, and/or the like) and the server may generate the payment request response message after receiving the payment method data from user device 106. The server may communicate the payment request response message to payment gateway system 116 and payment gateway system 116 may receive the payment request response message. In some non-limiting embodiments, the server may be associated with transaction service provider system 102, issuer system 104, merchant system 108, acquirer system 114, payment gateway system 116, and/or electronic wallet provider system 118.

As further shown in FIG. 4, at step 410, process 400 includes processing a payment transaction using payment method data. For example, payment gateway system 116 may process the payment transaction involving the user and the merchant using the payment method data received in the payment request response message. In some non-limiting embodiments, payment gateway system 116 may process the payment transaction by communicating the payment method data and/or transaction data associated with the payment transaction. For example, payment gateway system 116 may process the payment transaction by communicating a payment processing message, which includes the payment method data and/or transaction data, to transaction service provider system 102, issuer system 104, acquirer system 114, and/or electronic wallet provider system 118 so that the payment transaction may be authorized, settled, and/or cleared.

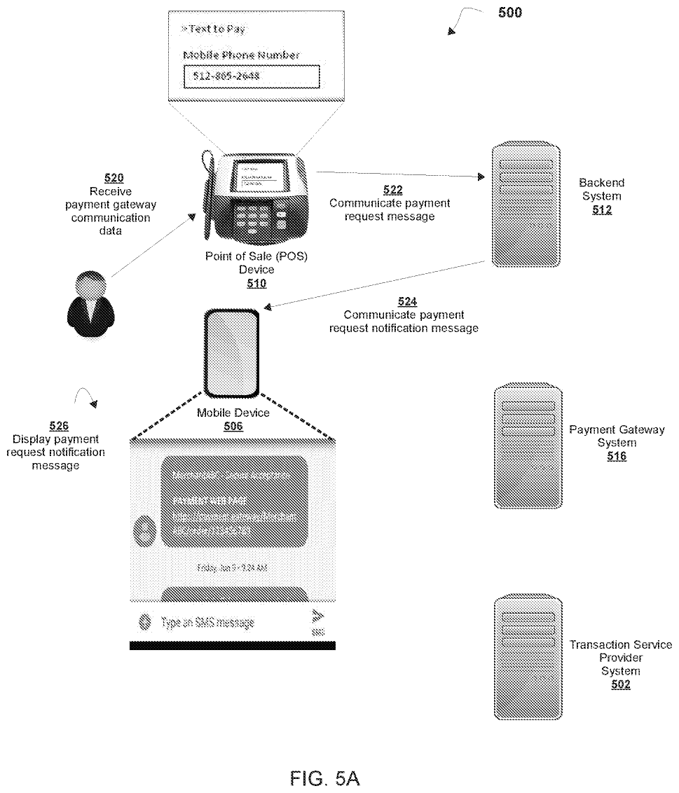

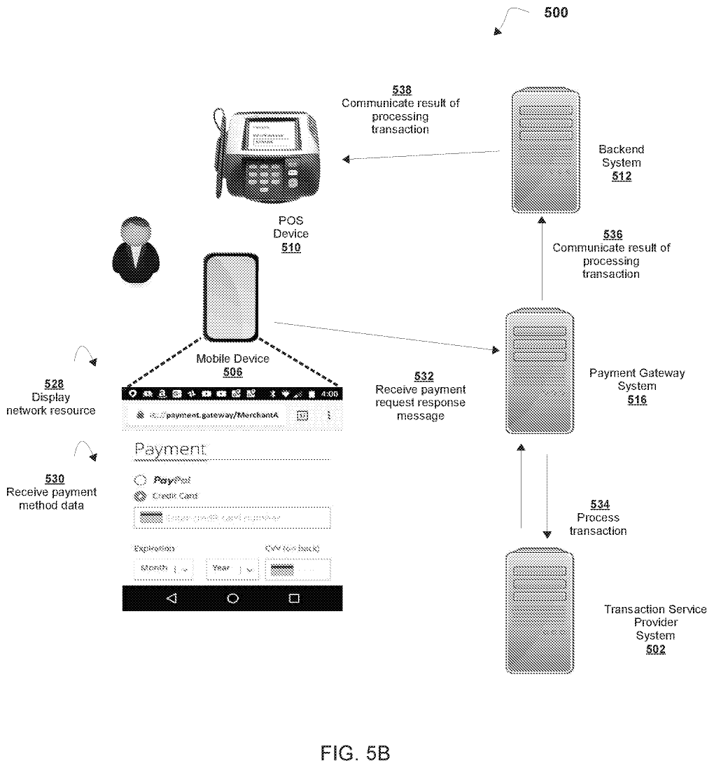

Referring now to FIGS. 5A and 5B, FIGS. 5A and 5B are diagrams of an overview of a non-limiting embodiment of an implementation 500 relating to process 400 shown in FIG. 4. As shown in FIGS. 5A and 5B, implementation 500 may include a user device (e.g., mobile device 506), POS device 510, backend system 512, payment gateway system 516, and transaction service provider system 502. In some non-limiting embodiments, the user device, shown as mobile device 506, may be the same as or similar to user device 106 as described above, POS device 510 may be the same as or similar to POS device 110 as described above, backend system 512 may be the same as or similar to backend system 112 as described above, payment gateway system 516 may be the same as or similar to payment gateway system 116 as described above, and transaction service provider system 502 may the same as or similar to transaction service provider system 102 as described above.

As shown by reference number 520 in FIG. 5A, POS device 510 may receive the payment gateway communication data from the user associated with mobile device 506. For example, POS device 510 may receive the payment gateway communication data after the user inputs the payment gateway communication data to an input component of POS device 510 during a payment transaction involving the user associated with mobile device 506 and a merchant associated with POS device 510. In some non-limiting embodiments, POS device 510 may generate a payment request message that includes the payment gateway communication data and/or transaction data associated with a payment transaction (e.g., a payment transaction involving the user and a merchant associated with POS device 510) based on receiving the payment gateway communication data. As shown by reference number 522, POS device 510 may communicate the payment request message to backend system 512. As shown by reference number 524, backend system 512 may communicate a payment request notification message to mobile device 506. In some non-limiting embodiments, backend system 512 may generate the payment request notification message based on receiving the payment request message from POS device 510. In some non-limiting embodiments, the payment request notification message may include data (e.g., payment gateway communication data, transaction data, and/or the like) that was included in the payment request message.

As shown by reference number 526, mobile device 506 may display the payment request notification message. For example, mobile device 506 may display the payment request notification message as a text message in a text messaging application on mobile device 506. The text message may include a link to a network resource (e.g., a web page) associated with payment gateway system 516.

As shown by reference number 528 in FIG. 5B, mobile device 506 may display the web page in a web browser application of mobile device 506 based on the user selecting the link to the web page. As shown by reference number 530, mobile device 506 may receive the payment method data (e.g., an account identifier, a credit card number, and/or the like) from the user and may communicate the payment method data to the web page. For example, mobile device 506 may communicate the payment method data to the web page based on the user selecting a user selectable element associated with an electronic wallet or the user selecting a user selectable element associated with a portable financial device (e.g., a credit card). Mobile device 506 may communicate the payment method data to the web page based on the user selecting an identifier of an electronic wallet associated with an electronic wallet mobile application on mobile device 506 after selecting the user selectable element associated with an electronic wallet. Mobile device 506 may communicate the payment method data to the web page based on the user selecting data associated with an account identifier stored by the web page, inputting an account identifier into a field of the web page, and/or the like, after the user selects a user selectable element associated with the portable financial device. In the example above, the payment method data is received by mobile device 506 and/or communicated by mobile device 506 independent of short range wireless communication connection between POS device 510 and mobile device 506.

As shown by reference number 532, payment gateway system 516 may receive a payment request response message including payment method data communicated by mobile device 506. For example, payment gateway system 516 may receive the payment request response message, which includes the payment method data provided by the user to mobile device 506. In some non-limiting embodiments, mobile device 506 may communicate the payment method data to payment gateway system 516 via the web page associated with payment gateway system 516 independent of a short range wireless communication connection between POS device 510 and mobile device 506. In some non-limiting embodiments, mobile device 506 may communicate the payment method data to a server (e.g., a web server associated with payment gateway system 516) that serves the web page and the server may communicate the payment request response message to payment gateway system 516.

As shown by reference number 534, payment gateway system 516 may process the payment transaction using the payment method data included in the payment request response message. For example, payment gateway system may communicate a message to transaction service provider system 502 that includes the payment method data so that the payment transaction may be processed by transaction service provider system 502.

As shown by reference 536, payment gateway system 516 may communicate a result of processing the payment transaction. For example, payment gateway system 516 may communicating a payment processing result message, which includes data associated with the result of processing the payment transaction. In some non-limiting embodiments, the data associated with the result of processing the payment transaction may include an indication that the payment transaction was successfully processed (e.g., accepted, authorized, cleared, settled, and/or the like) or not successfully processed (e.g., rejected, not authorized, not cleared, not settled, and/or the like), to backend system 512. As shown by reference 538, backend system 512 may communicate the result of processing the payment transaction to POS device 510. In some non-limiting embodiments, POS device 510 may display the indication that the payment transaction was successfully processed or not successfully processed.

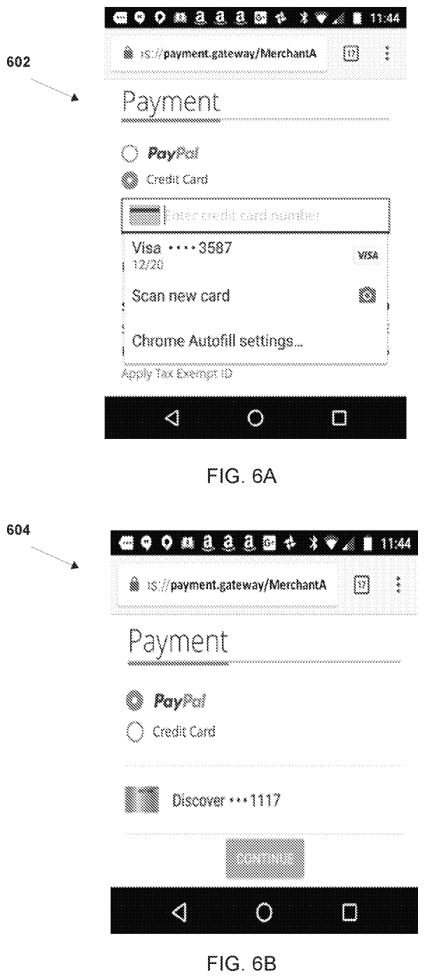

Referring now to FIGS. 6A and 6B, FIGS. 6A and 6B are non-limiting embodiments of user interface screens displayed by a user device (e.g., mobile device 506) as part of implementation 500 shown in FIGS. 5A and 5B. FIG. 6A is a user interface screen 602 displayed when a user associated with mobile device 506 selects a user selectable element associated with a portable financial device (e.g., a credit card) via the web page displayed by mobile device 506. FIG. 6B is a user interface screen 604 displayed when a user associated with mobile device 506 selects a user selectable element associated with an electronic wallet via the web page displayed by mobile device 506.

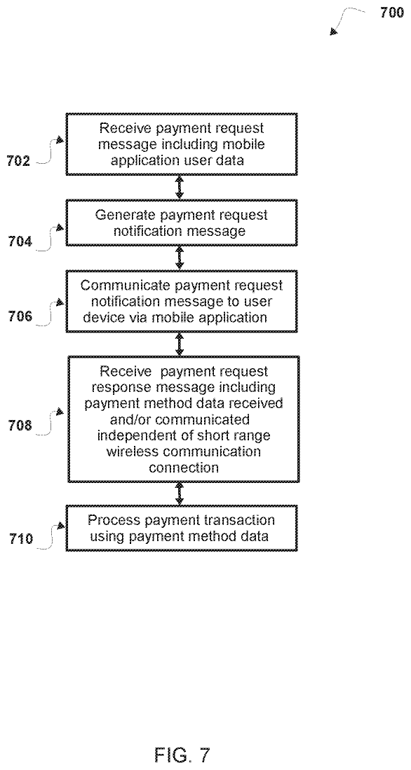

Referring now to FIG. 7, FIG. 7 is a flowchart of a non-limiting embodiment of a process 700 for conducting a payment transaction. In some non-limiting embodiments, one or more of the steps of process 700 may be performed (e.g., completely, partially, etc.) by payment gateway system 116 and/or electronic wallet provider system 118. In some non-limiting embodiments, one or more of the steps of process 700 may be performed (e.g., completely, partially, etc.) by another system, another device, another group of systems, or another group of devices, separate from or including payment gateway system 116 and/or electronic wallet provider system 118, such as transaction service provider system 102 (e.g., one or more devices of transaction service provider system 102), issuer system 104 (e.g., one or more devices of issuer system 104), user device 106, merchant system 108 (e.g., one or more devices of merchant system 108, POS device 110, backend system 112), or acquirer system 114 (e.g., one or more devices of acquirer system 114).

As shown in FIG. 7, at step 702, process 700 includes receiving a payment request message including mobile application user data. For example, payment gateway system 116 may receive the payment request message from merchant system 108 (e.g., POS device 110) including the mobile application user data. In some non-limiting embodiments, payment gateway system 116 may receive the payment request message from POS device 110 as part of a payment transaction involving a merchant associated with merchant system 108 and a user associated with user device 106. For example, backend system 112 may receive the payment request message from POS device 110 as part of the payment transaction before the payment transaction is processed.

In some non-limiting embodiments, payment gateway system 116 may receive the payment request message after merchant system 108 receives data (e.g., payment gateway user account data) from the user involved in a payment transaction with the merchant associated with merchant system 108. For example, payment gateway system 116 may receive the payment request message from POS device 110 after POS device 110 receives the payment gateway user account data from the user. POS device 110 may receive the payment gateway user account data from the user via an input component of POS device 110. In some non-limiting embodiments, payment gateway system 116 may receive the payment request message from backend system 112 after POS device 110 receives the payment gateway user account data from the user. For example, POS device 110 may receive the payment gateway user account data from the user via an input component of POS device 110. POS device may communicate the payment gateway user account data to backend system 112 and backend system 112 may receive the payment gateway user account data. Backend system 112 may generate the payment request message based on receiving the payment gateway user account data and backend system 112 may communicate the payment request message to payment gateway system 116.

In some non-limiting embodiments, POS device 110 may receive the payment gateway communication data after the user selects a payment process option associated with using a mobile application (e.g., a mobile device application, a native application for a mobile device, a mobile cloud application for a mobile device, and/or the like) associated with a payment gateway (e.g., payment gateway system 116) to communicate payment method data, where the payment process option is displayed by POS device 110. For example, POS device 110 may display a plurality of payment process options on an output component of POS device 110 and POS device 110 may receive a selection from the user of the payment process option. POS device 110 may receive the payment gateway user account data after receiving the selection of the payment process option.

In some non-limiting embodiments, the user may provide the payment gateway user account data to POS device 110. For example, the user may provide the payment gateway user account data to POS device 110 via an input component of POS device 110. In some non-limiting embodiments, POS device 110 may receive the payment gateway user account data after receiving a selection of a payment gateway associated with merchant system 108 from the user. For example, POS device 110 may display a plurality of identifiers for a plurality of payment gateways. The user may select an identifier associated with payment gateway system 116 and POS device 110 may receive the payment gateway user account data after the user selects the identifier associated with payment gateway system 116. In some non-limiting embodiments, POS device 110 may receive the payment gateway user account data based on the user manually inputting the payment gateway user account data to POS device 110. For example, after the user selects a payment process option to use a mobile application (e.g., a mobile device application, a native application for a mobile device, a mobile cloud application for a mobile device, and/or the like) associated with a payment gateway (e.g., payment gateway system 116) to communicate payment method data, POS device 110 may receive the payment gateway user account data from the user via a field displayed by POS device 110 in which the user may provide the payment gateway user account data.

In some non-limiting embodiments, merchant system 108 (e.g., POS device 110 and/or backend system 112) may generate the payment request message based on receiving the payment gateway user account data. For example, merchant system 108 may generate the payment request message based on receiving the payment gateway user account data from the user via an input component of POS device 110. In some non-limiting embodiments, merchant system 108 (e.g., POS device 110 and/or backend system 112) may communicate the payment request message to payment gateway system 116 based on generating the payment request message. For example, backend system 112 may communicate the payment request message to payment gateway system 116 based on generating the payment request message, where the payment request message is generated by backend system 112 based on receiving the payment gateway user account data from POS device 110.

In some non-limiting embodiments, electronic wallet provider system 118 may receive the payment request message from merchant system 108 (e.g., POS device 110 and/or backend system 112) and/or payment gateway system 116. In some non-limiting embodiments, electronic wallet provider system 118 may receive the payment request message from merchant system 108 (e.g., POS device 110 and/or backend system 112) and/or payment gateway system 116 as part of a payment transaction involving a merchant associated with merchant system 108 and a user associated with user device 106. For example, electronic wallet provider system 118 may receive the payment request message from merchant system 108 before the payment transaction is processed.

In some non-limiting embodiments, electronic wallet provider system 118 may receive the payment request message after merchant system 108 receives electronic wallet application user data (e.g., electronic wallet provider identification data and/or electronic wallet user account data) from the user involved in the payment transaction. For example, electronic wallet provider system 118 may receive the payment request message after POS device 110 receives the electronic wallet application user data from the user. POS device 110 may receive the electronic wallet application user data from the user via an input component of POS device 110. POS device 110 may communicate the electronic wallet application user data to backend system 112 and backend system 112 may communicate a payment request message to payment gateway system 116. Payment gateway system 116 may communicate a payment request message (e.g., a second payment request message) to electronic wallet provider system 118 after receiving the payment request message (e.g., a first payment request message) from backend system 112. In some non-limiting embodiments, electronic wallet provider system 118 may receive the payment request message from backend system 112 after POS device 110 receives the electronic wallet application user data from the user. For example, POS device 110 may receive the electronic wallet application user data from the user via an input component of POS device 110. POS device 110 may communicate the electronic wallet application user data to backend system 112 and backend system 112 may receive the electronic wallet application user data. Backend system 112 may generate the payment request message based on receiving the electronic wallet application user data and backend system 112 may communicate the payment request message (e.g., the payment request message including the electronic wallet application user data) to electronic wallet provider system 118.

In some non-limiting embodiments, POS device 110 may receive the electronic wallet application user data after the user selects a payment process option to use a mobile application (e.g., a mobile device application, a native application for a mobile device, a mobile cloud application for a mobile device, and/or the like) associated with an electronic wallet provider to communicate payment method data, where the payment process option is displayed by POS device 110. For example, POS device 110 may display a plurality of payment process options on an output component of POS device 110 and POS device 110 may receive a selection from the user of the payment process option. POS device 110 may receive the electronic wallet application user data after receiving the selection of the payment process option.

In some non-limiting embodiments, the user may provide the electronic wallet application user data (e.g., the electronic wallet provider identification data and/or the electronic wallet user account data) to POS device 110. For example, the user may provide the electronic wallet provider identification data and/or the electronic wallet application user data to POS device 110 via an input component of POS device 110. In some non-limiting embodiments, POS device 110 may receive the electronic wallet provider identification data based on a predetermined list of electronic wallet providers (e.g., electronic wallet providers associated with merchant system 108). For example, POS device 110 may display a plurality of identifiers for a plurality of electronic wallet providers. The user may select an identifier associated with an electronic wallet provider (e.g., electronic wallet provider system 118) and POS device 110 may receive the electronic wallet provider identification data based on the user selecting the identifier associated with the electronic wallet provider. In some non-limiting embodiments, POS device 110 may receive the electronic wallet provider identification data based on the user manually inputting the electronic wallet provider identification data to POS device 110. For example, after the user selects a payment process option to use a mobile application associated with an electronic wallet provider to communicate payment method data, POS device 110 may receive the electronic wallet provider identification data from the user via a field displayed by POS device 110.

In some non-limiting embodiments, the user may provide the electronic wallet user account data to POS device 110 after POS device 110 receives the electronic wallet provider identification data. For example, after the user selects an identifier associated with an electronic wallet provider (e.g., electronic wallet provider system 118) and POS device 110 receives the electronic wallet provider identification data, POS device 110 may display a field in which the user may provide the electronic wallet user account data. The user may provide the electronic wallet user account data to POS device 110 via the field and POS device 110 may receive the electronic wallet application user account data.

In some non-limiting embodiments, merchant system 108 (e.g., POS device 110 and/or backend system 112) may generate the payment request message based on receiving the electronic wallet application user data. For example, merchant system 108 may generate the payment request message based on receiving the electronic wallet application user data from the user via an input component of POS device 110. In some non-limiting embodiments, merchant system 108 (e.g., POS device 110 and/or backend system 112) may communicate the payment request message to electronic wallet provider system 118 based on generating the payment request message. For example, backend system 112 may communicate the payment request message to electronic wallet provider system 118 based on generating the payment request message, where the payment request message is generated by backend system 112 based on receiving the electronic wallet application user data from POS device 110.

In some non-limiting embodiments, merchant system 108 (e.g., POS device 110 and/or backend system 112) may communicate the electronic wallet application user data to payment gateway system 116 and payment gateway system 116 may communicate the payment request message to electronic wallet provider system 118 based on payment gateway system 116 generating the payment request message. In some non-limiting embodiments, payment gateway system 116 may communicate the payment request message to electronic wallet provider system 118 based on generating the payment request message, where the payment request message is generated by payment gateway system 116 based on receiving the electronic wallet application user data from merchant system 108.

As further shown in FIG. 7, at step 704, process 700 includes generating a payment request notification message. For example, payment gateway system 116 may generate the payment request notification message based on receiving the payment request message from merchant system 108.

In some non-limiting embodiments, payment gateway system 116 may receive the payment request message and determine a user account of the user having a mobile application associated with payment gateway system 116 based on the payment gateway user account data included in the payment request message. For example, payment gateway system 116 may determine the user account of the user by comparing the payment gateway user account data with user account identification data (e.g., an identifier associated with a user account, a user name of a user account, and/or the like) stored in a data structure (e.g., stored by payment gateway system 116 in a data structure). Payment gateway system 116 may determine the user account of the user by determining that the payment gateway user account data corresponds with the user account identification data of the user account. In some non-limiting embodiments, payment gateway system 116 may determine device identifier data associated with a device identifier of a user device (e.g., a network address of a user device, an IP address of a user device, a MAC address of a user device, a network address of user device 106, and/or the like) associated with the user account based on determining the user account. For example, payment gateway system 116 may determine the device identifier data based on determining the user account, where the device identifier data is stored with user account identification data in the user account.

In some non-limiting embodiments, payment gateway system 116 may generate the payment request notification message based on the data included in the payment request message. For example, payment gateway system 116 may generate the payment request notification message so that the payment request notification message includes the data (e.g., a portion of the data, all of the data, the payment gateway communication data, the communication channel type data, the communication channel user data, the transaction data, and/or the like) included in the payment request message.

In some non-limiting embodiments, electronic wallet provider system 118 may generate the payment request notification message based on receiving the payment request message from merchant system 108 and/or payment gateway system 116.

In some non-limiting embodiments, electronic wallet provider system 118 may receive the payment request message and determine a user account of the user having a mobile application associated with electronic wallet provider system 118 based on the electronic wallet user account data included in the payment request message. For example, electronic wallet provider system 118 may determine the user account of the user by comparing the electronic wallet user account data with user account identification data of a user account (e.g., an identifier associated with the user account, a user name of the user account, and/or the like) stored by electronic wallet provider system 118 in a data structure (e.g., a database and/or the like). Electronic wallet provider system 118 may determine the user account of the user by determining that the electronic wallet user account data corresponds with user account identification data of the user account. In some non-limiting embodiments, electronic wallet provider system 118 may determine device identifier data associated with a device identifier of user device 106 based on determining the user account of the user associated with user device 106. For example, electronic wallet provider system 118 may determine the device identifier data based on determining the user account, where the device identifier data is stored with user account identification data in the user account.

In some non-limiting embodiments, electronic wallet provider system 118 may generate the payment request notification message based on the data included in the payment request message. For example, electronic wallet provider system 118 may generate the payment request notification message so that the payment request notification message includes the data (e.g., a portion of the data, all of the data, the electronic wallet application user data, the electronic wallet provider identification data, the electronic wallet user account data, the transaction data, and/or the like) included in the payment request message.

As further shown in FIG. 7, at step 706, process 700 includes communicating a payment request notification message to a user device (e.g., user device 106) via a mobile application. For example, payment gateway system 116 may communicate the payment request notification message to user device 106 (e.g., a mobile device) associated with the user involved in the payment transaction with the merchant associated with merchant system 108 via the mobile application (e.g., a mobile application associated with payment gateway system 116, and/or a mobile application associated with electronic wallet provider system 118). In some non-limiting embodiments, payment gateway system 116 may communicate the payment request notification message to user device 106 via the mobile application based on generating the payment request notification message.

In some non-limiting embodiments, payment gateway system 116 may communicate the payment request notification message to user device 106 (e.g., to a mobile application on user device 106) based on device identifier data associated with a device identifier of user device 106. For example, payment gateway system 116 may communicate the payment request notification message to a mobile application on user device 106 using device identifier data that was determined to be stored with the user account of the user associated with user device 106. In some non-limiting embodiments, payment gateway system 116 may communicate the payment request notification message to user device 106 based on a push notification and/or a pull notification.

In some non-limiting embodiments, electronic wallet provider system 118 may communicate the payment request notification message to user device 106 (e.g., a mobile device) associated with the user involved in the payment transaction with the merchant associated with merchant system 108. In some non-limiting embodiments, electronic wallet provider system 118 may communicate the payment request notification message based on generating the payment request notification message.

In some non-limiting embodiments, electronic wallet provider system 118 may communicate the payment request notification message to user device 106 (e.g., to a mobile application on user device 106) based on device identifier data associated with a device identifier of user device 106 (e.g., a network address of user device 106, an IP address of user device 106, a MAC address of user device 106, and/or the like). For example, electronic wallet provider system 118 may communicate the payment request notification message to a mobile application associated with electronic wallet provider system 118 on user device 106 using device identifier data that was determined to be stored with the user account of the user associated with user device 106. In some non-limiting embodiments, electronic wallet provider system 118 may communicate the payment request notification message to user device 106 based on a push notification and/or a pull notification.

As further shown in FIG. 7, at step 708, process 700 includes receiving a payment request response message including payment method data received and/or communicated independent of a short range wireless communication connection. For example, payment gateway system 116 may receive a payment request response message including payment method data received and/or communicated by user device 106 independent of a short range wireless communication connection (e.g., a short range wireless communication connection between user device 106 and POS device 110). In some non-limiting embodiments, payment gateway system 116 may receive the payment request response message based on the user providing an input (e.g., to user device 106), where the input includes payment method data for a payment transaction, to a mobile application (e.g., a mobile application stored on user device 106) associated with payment gateway system 116. For example, user device 106 may receive the payment request notification message from payment gateway system 116. User device 106 may display a user interface screen of the mobile application. The user may provide an input to the user interface screen of the mobile application displayed on user device 106, where the input may include payment method data (e.g., an account identifier, a token, a payment card number, a credit card number, and/or the like), independent of a short range wireless communication connection between user device 106 and POS device 110.

In some non-limiting embodiments, user device 106 may receive the payment method data based on the user providing the payment method data via the mobile application associated with payment gateway system 116. For example, the user may provide the payment method data in a field of the user interface screen of the mobile application by inputting an account identifier into the field of the user interface screen by selecting an account identifier (e.g., a token that is stored on user device 106) via the mobile application, by selecting an account identifier (e.g., a token that is stored remotely from user device 106) via the mobile application, and/or the like. In another example, the user may provide the payment method data (e.g., an account identifier and/or the like) to user device 106 based on the user selecting a mobile application associated with an electronic wallet provider (e.g., electronic wallet provider system 118) on user device 106. In such an example, user device 106 may communicate the payment method data to payment gateway system 116 via the mobile application based on an API call.

In some non-limiting embodiments, user device 106 may generate the payment request response message after receiving the payment method data and user device 106 may communicate the payment request response message independent of a short range wireless communication connection (e.g., independent of a short range wireless communication connection between user device 106 and POS device 110). For example, user device 106 may generate the payment request response message, which includes the payment method data, based on receiving the payment method data. User device 106 may communicate the payment request response message to payment gateway system 116 based on generating the payment request response message and payment gateway system 116 may receive the payment request response message.

In some non-limiting embodiments, user device 106 may receive the payment method data and communicate the payment method data to a server (e.g., a web server, and/or the like) and the server may generate the payment request response message after receiving the payment method data from user device 106. The server may communicate the payment request response message to payment gateway system 116 and payment gateway system 116 may receive the payment request response message. In some non-limiting embodiments, the server may be associated with transaction service provider system 102, issuer system 104, merchant system 108, acquirer system 114, payment gateway system 116, and/or electronic wallet provider system 118.

In some non-limiting embodiments, electronic wallet provider system 118 may receive the payment request response message including payment method data received by and/or communicated by user device 106 independent of a short range wireless communication connection (e.g., a short range wireless communication connection between user device 106 and POS device 110). In some non-limiting embodiments, electronic wallet provider system 118 may receive the payment request response message based on the user providing an input, where the input includes payment method data for the payment transaction, to a mobile application associated with electronic wallet provider system 118 stored on user device 106. For example, user device 106 may receive the payment request notification message from electronic wallet provider system 118. User device 106 may display a user interface screen of the mobile application associated with electronic wallet provider system 118. The user may provide an input to the user interface screen of the mobile application displayed on user device 106, where the input may include payment method data (e.g., an account identifier, a token, a payment card number, a credit card number, and/or the like).

In some non-limiting embodiments, user device 106 may receive the payment method data based on the user providing the payment method data to user device 106 via the mobile application associated with electronic wallet provider system 118. For example, the user may provide the payment method data in a field of the user interface screen of the mobile application by inputting an account identifier into the field of the user interface screen, by selecting an account identifier (e.g., a token that is stored on user device 106) via the mobile application, by selecting an account identifier (e.g., a token that is stored remotely from user device 106) via the mobile application, and/or the like.

In some non-limiting embodiments, user device 106 may generate the payment request response message after receiving the payment method data and user device 106 may communicate the payment request response message to electronic wallet provider system 118. For example, user device 106 may generate the payment request response message, which includes the payment method data, based on receiving the payment method data. User device 106 may communicate the payment request response message to electronic wallet provider system 118 based on generating the payment request response message and electronic wallet provider system 118 may receive the payment request response message.

In some non-limiting embodiments, user device 106 may receive the payment method data and communicate the payment method data to a server (e.g., a web server, and/or the like) and the server may generate the payment request response message after receiving the payment method data from user device 106. The server may communicate the payment request response message to electronic wallet provider system 118 and electronic wallet provider system 118 may receive the payment request response message. In some non-limiting embodiments, the server may be associated with transaction service provider system 102, issuer system 104, merchant system 108, acquirer system 114, payment gateway system 116, and/or electronic wallet provider system 118.

As further shown in FIG. 7, at step 710, process 700 includes processing the payment transaction using payment method data. For example, payment gateway system 116 may process the payment transaction involving the user associated with user device 106 and the merchant associated with merchant system 108 using the payment method data included in the payment request response message. In some non-limiting embodiments, payment gateway system 116 may process the payment transaction by communicating the payment method data and/or the transaction data associated with the payment transaction. For example, payment gateway system 116 may process the payment transaction by communicating a payment processing message, which includes the payment method data and/or the transaction data, to transaction service provider system 102, issuer system 104, acquirer system 114, and/or electronic wallet provider system 118 so that the payment transaction may be authorized, settled, and/or cleared.

In some non-limiting embodiments, electronic wallet provider system 118 may process the payment transaction involving the user associated with user device 106 and the merchant associated with merchant system 108 using the payment method data included in the payment request response message. In some non-limiting embodiments, electronic wallet provider system 118 may process the payment transaction by communicating the payment method data and/or the transaction data associated with the payment transaction. For example, electronic wallet provider system 118 may process the payment transaction by communicating a payment processing message, which includes the payment method data and/or the transaction data, to transaction service provider system 102, issuer system 104, acquirer system 114, and/or payment gateway system 116 so that the payment transaction may be authorized, settled, and/or cleared.

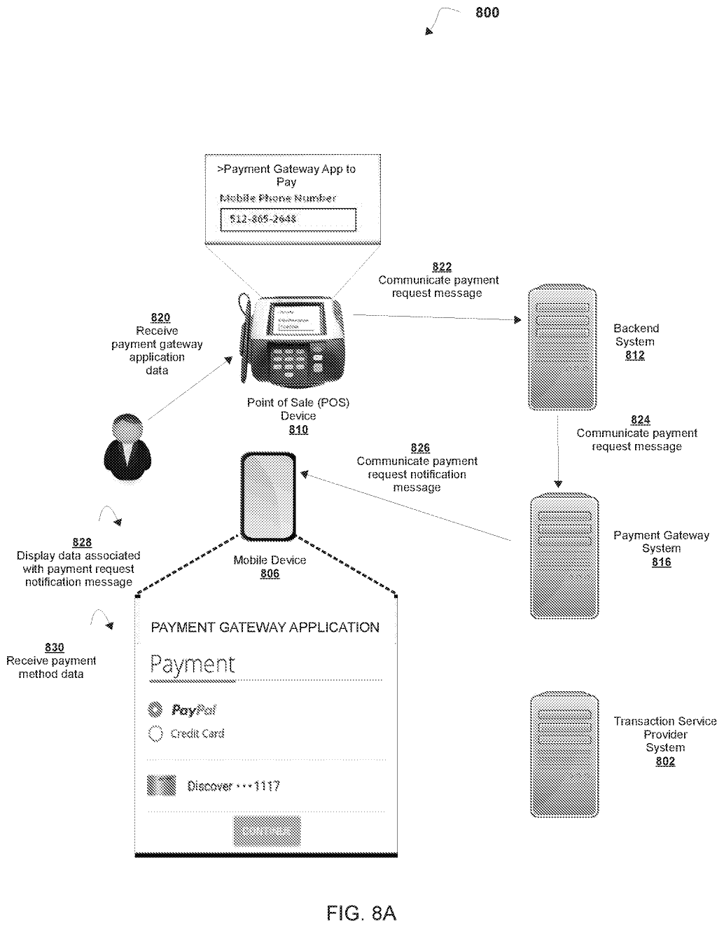

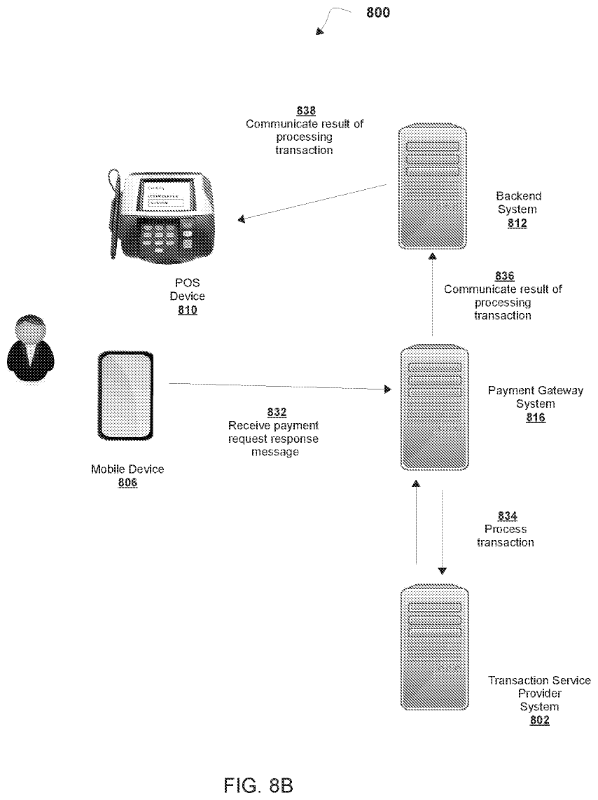

Referring now to FIGS. 8A and 8B, FIGS. 8A and 8B are diagrams of an overview of a non-limiting embodiment of an implementation 800 relating to process 700 shown in FIG. 7. As shown in FIGS. 8A and 8B, implementation 800 may include a user device (e.g., mobile device 806), POS device 810, backend system 812, payment gateway system 816, and transaction service provider system 802. In some non-limiting embodiments, the user device, shown as mobile device 806, may be the same as or similar to user device 106 or mobile device 506 as described above, POS device 810 may be the same as or similar to POS device 110 or POS device 510 as described above, backend system 812 may be the same as or similar to backend system 112 or backend system 512 as described above, payment gateway system 816 may be the same as or similar to payment gateway system 116 or payment gateway system 516 as described above, and transaction service provider system 802 may the same as or similar to transaction service provider system 102 or transaction service provider system 502 as described above.

As shown by reference number 820 in FIG. 8A, POS device 810 may receive payment gateway user account data from a user associated with mobile device 806. For example, POS device 810 may receive the payment gateway user account data based on the user inputting the payment gateway user account data to an input component of POS device 810 during a payment transaction involving the user associated with mobile device 806 and a merchant associated with POS device 810. In some non-limiting embodiments, POS device 810 may generate a payment request message (e.g., a first payment request message) that includes the payment gateway user account data and/or transaction data associated with a payment transaction (e.g., a payment transaction involving the user and a merchant associated with POS device 810) based on receiving the payment gateway user account data. As shown by reference number 822, POS device 810 may communicate the payment request message to backend system 812. As shown by reference number 824, backend system 812 may communicate a payment request message (e.g., a second payment request message) to payment gateway system 116. In some non-limiting embodiments, payment gateway system 116 may generate a payment request notification message based on receiving the payment request message from backend system 812. In some non-limiting embodiments, the payment request notification message may include data (e.g., payment gateway communication data, transaction data, and/or the like) that was included in the payment request message (e.g., the first payment request message and/or the second payment request message). As shown by reference number 826, payment gateway system 816 may communicate the payment request notification message to mobile device 806.

As shown by reference number 828, mobile device 806 may receive the payment request notification message and display data associated with the payment request notification message. For example, mobile device 806 may receive the payment request notification message and display the data associated with the payment request notification message in a user interface screen of a mobile application associated with payment gateway system 816. In some non-limiting embodiments, the user interface screen may include transaction data associated with the payment transaction that was included in the payment request notification message. In some non-limiting embodiments, mobile device 806 may display the user interface screen of the mobile application associated with payment gateway system 816 based on receiving the payment request notification message from payment gateway system 816.

As shown by reference number 830, mobile device 806 may receive payment method data (e.g., an account identifier, a credit card number, and/or the like) from the user via the user interface screen of the mobile application. For example, mobile device 806 may receive the payment method data via the mobile application based on the user selecting a user selectable element associated with an electronic wallet or based on the user selecting a user selectable element associated with a portable financial device (e.g., a credit card). In some non-limiting embodiments, mobile device 806 may communicate the payment method data via the mobile application based on the user selecting an identifier of an electronic wallet associated with an electronic wallet mobile application on mobile device 806 after the user selects the user selectable element associated with an electronic wallet. Additionally or alternatively, mobile device 806 may communicate the payment method data via the mobile application based on the user selecting data associated with an account identifier stored on mobile device 806 (e.g., stored by the mobile application on mobile device 806), based on the user inputting an account identifier into a field of the user interface screen of the mobile application, and/or the like, after the user selects a user selectable element associated with the portable financial device. In the example above, the payment method data is received by and/or communicated by mobile device 806 independent of short range wireless communication connection between POS device 810 and mobile device 806.

As shown by reference number 832 in FIG. 8B, payment gateway system 816 may receive a payment request response message (e.g., from mobile device 806). For example, payment gateway system 816 may receive the payment request response message, which includes the payment method data provided by the user and received independent of short range wireless communication connection between POS device 810 and mobile device 806, based on the user providing the payment method data to mobile device 806 via the mobile application associated with payment gateway system 816. In some non-limiting embodiments, as shown by reference number 834, payment gateway system 816 may process the payment transaction using the payment method data included in the payment request response message. For example, payment gateway system 816 may communicate the payment method data (e.g., a payment processing message that includes the payment method data) to transaction service provider system 802 so that the payment transaction may be processed by transaction service provider system 802.

As shown by reference 836, payment gateway system 816 may communicate a result of processing the payment transaction. For example, payment gateway system 816 may communicate a payment processing result message, which includes data associated with the result of processing the payment transaction. In some non-limiting embodiments, the data associated with the result of processing the payment transaction includes an indication that the payment transaction was successfully processed or not successfully processed to backend system 812. As shown by reference 838, backend system 812 may communicate the result of processing the payment transaction to POS device 810. In some non-limiting embodiments, POS device 810 may display the indication that the payment transaction was successfully processed or not successfully processed.

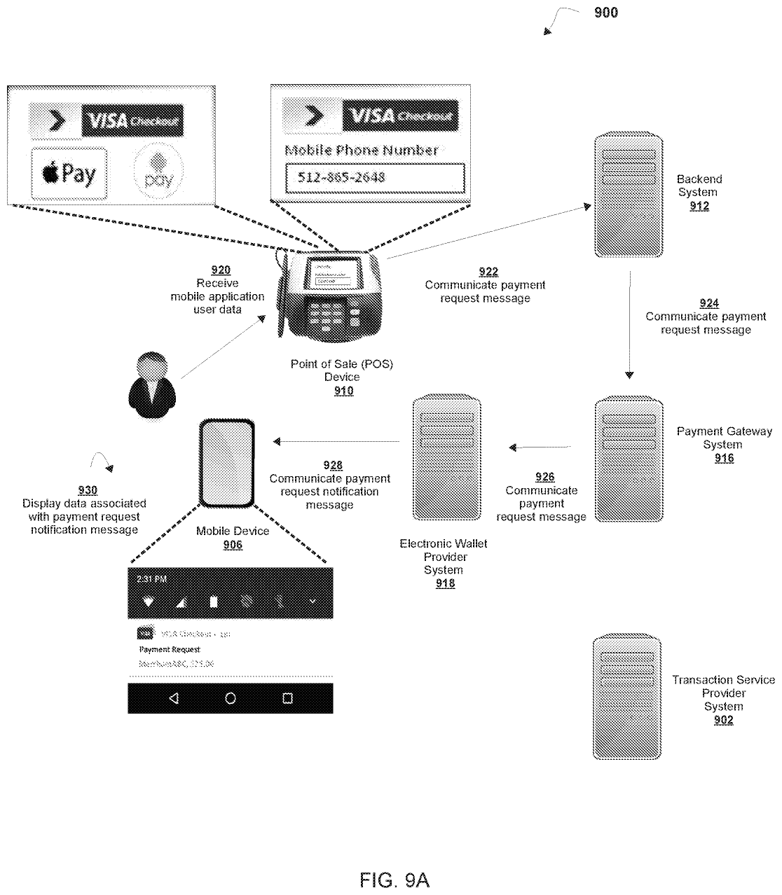

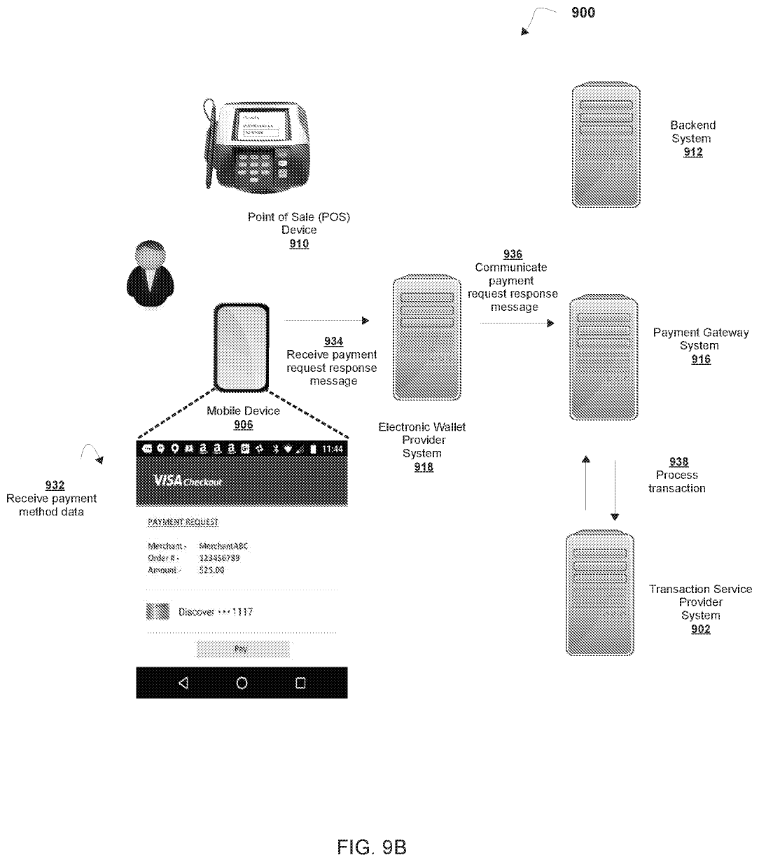

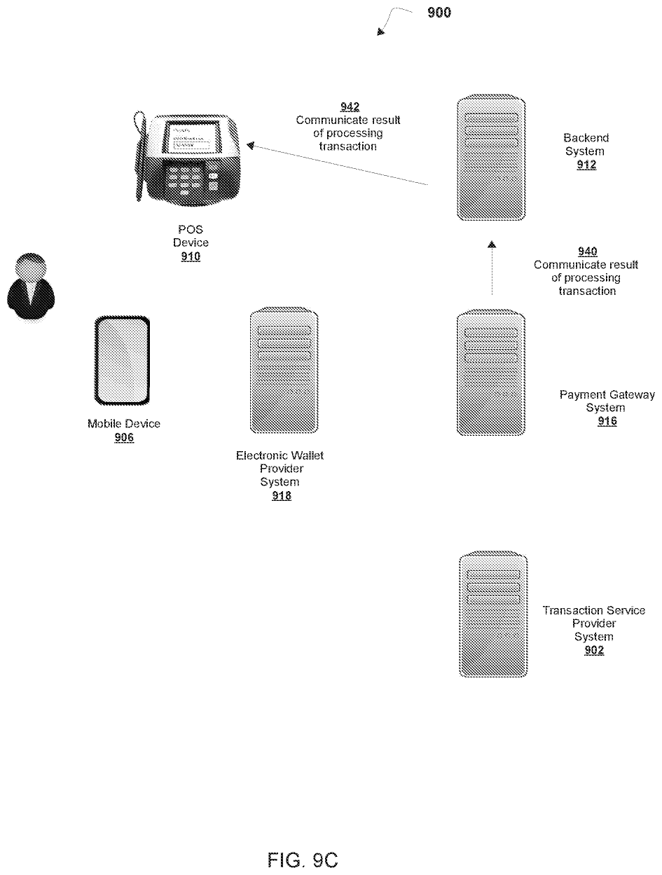

Referring now to FIGS. 9A-9C, FIGS. 9A-9C are diagrams of an overview of a non-limiting embodiment of an implementation 900 relating to process 700 shown in FIG. 7. As shown in FIGS. 9A-9C, implementation 900 may include transaction service provider system 902, a user device (e.g., mobile device 906), POS device 910, backend system 912, payment gateway system 916, and electronic wallet provider system 918. In some non-limiting embodiments, transaction service provider system 902 may the same as or similar to transaction service provider system 102, transaction service provider system 502, and/or transaction service provider system 802 as described above, the user device, shown as mobile device 906, may be the same as or similar to user device 106, mobile device 506, and/or mobile device 806 as described above, POS device 910 may be the same as or similar to POS device 110, POS device 510, and/or POS device 810 as described above, backend system 912 may be the same as or similar to backend system 112, backend system 512, and/or backend system 812 as described above, payment gateway system 916 may be the same as or similar to payment gateway system 116, payment gateway system 516, and/or payment gateway system 816 as described above, and electronic wallet provider system 918 may be the same or similar to electronic wallet provider system 118 as described above.

As shown by reference number 920 in FIG. 9A, POS device 910 may receive electronic wallet application user data (e.g., electronic wallet provider identification data and/or electronic wallet user account data) from a user associated with mobile device 906. For example, POS device 910 may receive the electronic wallet application user data based on the user inputting the electronic wallet application user data to an input component of POS device 910 during a payment transaction involving the user associated with mobile device 906 and a merchant associated with POS device 910.

In some non-limiting embodiments, POS device 910 may generate a payment request message (e.g., a first payment request message) that includes the electronic wallet application user data and/or transaction data associated with the payment transaction based on receiving the electronic wallet application user data. As shown by reference number 922, POS device 910 may communicate the payment request message to backend system 912. As shown by reference number 924, backend system 912 may communicate a payment request message (e.g., a second payment request message) to payment gateway system 116. As shown by reference number 926, payment gateway system 116 may communicate a payment request message (e.g., a third payment request message) to electronic wallet provider system 918.

In some non-limiting embodiments, electronic wallet provider system 918 may generate a payment request notification message based on receiving the payment request message from payment gateway system 916. In some non-limiting embodiments, the payment request notification message may include data (e.g., a portion of the data, all of the data, the electronic wallet application user data, the electronic wallet provider identification data, the electronic wallet user account data, the transaction data, and/or the like) that was included in the payment request message (e.g., the first payment request message, the second payment request message, and/or the third payment request message). As shown by reference number 928, payment gateway system 916 may communicate the payment request notification message to mobile device 906.

As shown by reference number 930, mobile device 906 may receive the payment request notification message and display data associated with the payment request notification message. For example, mobile device 906 may receive the payment request notification message and display the data associated with the payment request notification message in a user interface screen of a mobile application associated with electronic wallet provider system 918. In some non-limiting embodiments, the user interface screen may include transaction data associated with the payment transaction included in the payment request notification message. In some non-limiting embodiments, mobile device 906 may display a user interface screen of the mobile application associated with electronic wallet provider system 918 based on receiving the payment request notification message from electronic wallet provider system 918.

As shown by reference number 932 in FIG. 9B, mobile device 906 may receive payment method data from the user via the user interface screen of the mobile application independent of short range wireless communication connection between POS device 910 and mobile device 906. In some non-limiting embodiments, mobile device 906 may receive the payment method data and may communicate the payment method data via a mobile application based on the user selecting a user selectable element associated with a portable financial device (e.g., a credit card). In some non-limiting embodiments, mobile device 906 may communicate the payment method data via the mobile application based on the user selecting an identifier of a portable financial device. Additionally or alternatively, mobile device 906 may communicate the payment method data via the mobile application based on the user selecting data associated with an account identifier (e.g., an account identifier stored on mobile device 906 and/or an account identifier stored remotely from mobile device 906) displayed in a field of the user interface screen of the mobile application, based on the user inputting an account identifier into a field of the user interface screen of the mobile application, and/or the like. In some non-limiting embodiments, mobile device 906 may communicate the payment method data after the user selects a user selectable element associated with the portable financial device. In the example above, the payment method data is received and/or communicated by mobile device 906 (e.g., communicated to electronic wallet provider system 918 via the mobile application on mobile device 906) independent of short range wireless communication connection between POS device 910 and mobile device 906.

As shown by reference number 934, electronic wallet provider system 918 may receive a payment request response message (e.g., from mobile device 906). For example, electronic wallet provider system 918 may receive the payment request response message, which includes the payment method data received and/or communicated by mobile device 906 independent of a short range wireless communication connection between POS device 910 and mobile device 906. Electronic wallet provider system 918 may receive the payment method data based on mobile device 906 communicating the payment method data via the mobile application associated with electronic wallet provider system 918.

As shown by reference number 936, electronic wallet provider system 918 may communicate a payment request response message (e.g., a second payment request response message), which includes the payment method data, to payment gateway system 916 based on receiving the payment request response message (e.g., a first payment request response message) that includes the payment method data received and/or communicated by mobile device 906. As shown by reference number 938, payment gateway system 916 may process the payment transaction using the payment method data included in the payment request response message received from electronic wallet provider system 918. For example, payment gateway system 916 may communicate a payment processing message to transaction service provider system 902 that includes the payment method data so that the payment transaction may be processed by transaction service provider system 902.

As shown by reference number 940 in FIG. 9C, payment gateway system 916 may communicate a result of processing the payment transaction. For example, payment gateway system 916 may communicate a message, which includes data associated with the result of processing the payment transaction. In some non-limiting embodiments, the data associated with the result of processing the payment transaction may include an indication that the payment transaction was successfully processed or not successfully processed to backend system 912. As shown by reference number 942, backend system 912 may communicate the result of processing the payment transaction to POS device 910. In some non-limiting embodiments, POS device 910 may display the indication that the payment transaction was successfully processed or not successfully processed.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

1. A computer-implemented method for conducting a payment transaction, the method comprising:
receiving, with at least one processor, payment gateway communication data associated with a communication channel of a user;
communicating, with at least one processor, a payment request message based on receiving the payment gateway communication data, wherein the payment request message comprises the payment gateway communication data;
generating, with at least one processor, a payment request notification message based on receiving the payment request message, wherein the payment request notification message comprises a link to a network resource associated with a payment gateway system;
communicating, with at least one processor, the payment request notification message to a user device associated with the user, wherein communicating the payment request notification message comprises communicating the payment request notification message using the communication channel associated with the payment gateway communication data;
receiving, with at least one processor, a payment request response message, wherein the payment request response message comprises payment method data communicated by the user device independent of a short range wireless communication connection, wherein the payment method data is communicated via the network resource associated with the payment gateway system; and
processing, with at least one processor, at least one payment transaction involving the user and a merchant using the payment method data communicated via the network resource.

2. The method of claim 1, wherein the payment gateway communication data comprises at least one of the following:
communication channel type data associated with a type of the communication channel of the user;
communication channel user data associated with contact information of the user; or
any combination thereof.

3. The method of claim 2, wherein communicating the payment request notification message to the user device comprises communicating the payment request notification message to the user device based at least partially on the communication channel type data, the communication channel user data, or any combination thereof.

4. The method of claim 1, further comprising:
receiving transaction data associated with the at least one payment transaction, wherein the transaction data comprises transaction identifier data associated with an identifier of the at least one payment transaction, and wherein generating the payment request notification message comprises:
generating the link to the network resource associated with the payment gateway system based on the transaction identifier data.

5. The method of claim 1, wherein the user device comprises a mobile device, wherein the payment gateway communication data comprises communication channel user data, and wherein the communication channel user data comprises at least one of the following:
a mobile device number of the mobile device associated with the user,
an email address of an email account associated with the user, or
a user name of a social media account associated with the user, and
wherein communicating the payment request notification message using the communication channel associated with the payment gateway communication data comprises:
communicating the payment request notification message using the communication channel associated with the mobile device number of the mobile device associated with the user, the email address of an email account associated with the user, or the social media account associated with the user.

6. The method of claim 1, further comprising:
receiving transaction data associated with the at least one payment transaction; and
generating the link to the network resource based at least partially on at least one of the following:
a merchant order identifier included in the transaction data,
a point-of-sale device identifier included in the transaction data,
a transaction identifier included in the transaction data, or
any combination thereof.

7. A system for conducting a payment transaction, the system comprising:
at least one processor, wherein the at least one processor is programmed or configured to:
receive payment gateway communication data associated with a communication channel of a user;
communicate a payment request message based on receiving the payment gateway communication data, wherein the payment request message comprises the payment gateway communication data;
generate a payment request notification message based on receiving the payment request message, wherein the payment request notification message comprises a link to a network resource associated with a payment gateway system;
communicate the payment request notification message to a user device associated with the user using the communication channel associated with the payment gateway communication data;
receive a payment request response message, wherein the payment request response message comprises payment method data communicated by the user device independent of a short range wireless communication connection, and wherein the payment method data is communicated via the network resource associated with the payment gateway system; and
process at least one payment transaction involving the user and a merchant using the payment method data communicated via the network resource.

8. The system of claim 7, wherein the at least one processor comprises a processor of a point-of-sale (POS) device associated with the merchant, and wherein the processor of the POS device is programmed or configured to:
receive the payment gateway communication data; and
communicate the payment gateway communication data.

9. The system of claim 7, wherein the at least one processor is further programmed or configured to:
receive a message comprising data associated with a result of processing the payment transaction.

10. The system of claim 7, wherein the at least one processor, when receiving the payment gateway communication data associated with the communication channel of the user, is programmed or configured to:
receive communication channel type data associated with a type of the communication channel of the user; and
receive communication channel user data associated with contact information of the user after receiving the communication channel type data.

11. The system of claim 7, wherein the network resource comprises a web page associated with the payment gateway system, and wherein the link comprises a Uniform Resource Locator for the web page.

12. The system of claim 7, wherein the short range wireless communication connection is a short range wireless communication connection between the user device associated with the user and a point-of-sale device associated with the merchant.

13. The system of claim 7, wherein the at least one processor, when communicating the payment request notification message to the user device associated with the user, is programmed or configured to:
communicate a text message to the user device associated with the user, wherein the text message comprises the link to the network resource.

14. The system of claim 7, wherein the at least one processor comprises a processor of the payment gateway system, the processor of the payment gateway system is programmed or configured to:
communicate the payment request notification message to the user device associated with the user; and
receive the payment request response message that comprises payment method data communicated by the user device.

15. A computer program product for conducting a payment transaction, the computer program product comprising at least one non-transitory computer-readable medium including one or more instructions that, when executed by at least one processor, cause the at least one processor to:
receive payment gateway communication data associated with a communication channel of a user;
communicate a payment request message, wherein the payment request message comprises the payment gateway communication data;
generate a payment request notification message based on receiving the payment request message, wherein the payment request notification message comprises a link to a network resource associated with a payment gateway system;
communicate the payment request notification message to a user device associated with the user using the communication channel associated with the payment gateway communication data;
receive a payment request response message, wherein the payment request response message comprises payment method data communicated by the user device independent of a short range wireless communication connection, and wherein the payment method data is communicated via the network resource associated with the payment gateway system; and
process at least one payment transaction involving the user and a merchant using the payment method data communicated via the network resource.

16. The computer program product of claim 15, wherein the one or more instructions, that cause the at least one processor to generate the payment request notification message, cause the at least one processor to:
generate the link to the network resource based on transaction data associated with at least one payment transaction.

17. The computer program product of claim 15, wherein the network resource comprises a web page associated with the payment gateway system and wherein the link comprises a Uniform Resource Locator for the web page.

18. The computer program product of claim 15, wherein the one or more instructions, when executed by the at least one processor, further cause the at least one processor to:
receive a message comprising data associated with a result of processing the at least one payment transaction.

19. The computer program product of claim 15, wherein the one or more instructions, when executed by the at least one processor, further cause the at least one processor to:
communicate the payment method data to a transaction service provider system based on receiving the payment request response message.

20. The computer program product of claim 15, wherein the one or more instructions, when executed by the at least one processor, further cause the at least one processor to:
generate the payment request message, wherein the payment request message comprises the payment gateway communication data and transaction data associated with the at least one payment transaction involving the user and the merchant.

21.-40. (canceled)
